(19) United States
(12) Patent Application Publication
(10) Pub. No.: US 2023/0122289 A1
(43) Pub. Date: Apr. 20, 2023

(54) FUNCTIONALIZED SILICA PARTICLES AND THEIR USE

(71) Applicant: MOMENTIVE PERFORMANCE MATERIALS GMBH, Leverkusen (DE)

(72) Inventors: Thorsten FELDER, Düsseldorf (DE); Gunnar HOFFMÜLLER, Odenthal (DE); Anita WITOSSEK, Langenfeld (DE); Jörg-Walter HERMANN, Leichlingen (DE); Andreas HAEUSELER, Köln (DE); Jan ENGELHARDT, Solingen (DE); Max CONRAD, Solingen (DE); Monika FRIEDRICHS, Kerpen (DE)

(21) Appl. No.: 17/910,883

(22) PCT Filed: Mar. 9, 2021
(86) PCT No.: PCT/EP2021/055875

§ 371 Date: Sep. 12, 2022

(30) Foreign Application Priority Data
Mar. 13, 2020 (EP) 20163031.6

(51) Int. Cl. C07F 7/10; C08K 9/06; C09D 7/62

(52) U.S. Cl. CPC C07F 7/10; C08K 9/06; C09D 7/62

(57) ABSTRACT

The present invention refers to silica particles functionalized with one or more silanes comprising a terminal group enabling a condensation reaction with the silica particles' surface, and at least one further terminal group for the modification of the silica particles' properties. The invention also relates to a process for the functionalization of silica particles by silanes, silanes as applied for the functionalization of the silica particles according to the invention, a process for the functionalization of silica by silanes, silica particles comprising a functional group, the use of the silica particles according to the invention, and coating compositions comprising the silica particles according to the invention.

### FIELD OF THE INVENTION

The invention relates to silica particles functionalized with one or more silanes and their use in applications, e.g. anti-fouling or anti-fog coatings, a process for the functionalization of silica particles, and to specific silanes as used for the functionalization of silica particles. The invention relates as well to coating compositions comprising such functionalized silica particles. The anti-fouling project received funding from the Federal Ministry of Economic Affairs and Energy Germany under “grant agreement” 03SX370H.

### BACKGROUND ART

Coatings containing hydrophilic materials, e.g. polyether functionalized silicone derivatives, such as disclosed in EP3325540 A1, have demonstrated a significant reduction of the attachment strength of marine organism on surfaces. In addition, these additives formulated into thermal acrylic clearcoats have been demonstrated to be effective as anti-fog agents.

### Problem to be Solved

However, the addition of functionalized less-branched, long-chain silicone derivatives or polyethers to a coating formulation can progressively lower the hardness of the coating, and thus reduce the impact and the scratch resistance. Such properties are prerequisites for a successful application of the coating formulation product in areas like marine anti-fouling or hard coats and clearcoats for automotive head lights. In order to mitigate the hardness reducing effect of the additive, a filler material, e.g. surface treated silica or other particle species, may be added but can lead to more complex formulation mixtures and thus is undesirable.

### SUMMARY OF THE INVENTION

The above problem is solved by the provision of silica particles functionalized with one or more silanes having specific structural features, e.g. coating the silica particles with the anti-fouling additive or anti-fog additive, respectively.

The softening effect to the coating through the additive itself is directly counterbalanced by the hardness properties of the silica particles. In addition, through the combination of the particles and the anti-fouling additive, the overall applicability is improved as the complexity of the final coating formulation is reduced. Therefore, the requisite hardness and anti-fouling/anti-fog properties can be introduced into a coating formulation simultaneously. Further, in addition to the aforementioned benefits, the silica particles according to the invention can be integrated into the coating matrix and at the same time bear functional groups rendering the silica particles hydrophobic, hydrophilic or provide the coating with specific properties, such as anti-fouling or antimicrobial properties. According to the invention, the silica particles can be functionalized as described in the following embodiments.

In an aspect, the present invention relates to silica particles functionalized with one or more silanes of the formula:

HN[—SiR¹₂-A]₂ (1),

and/or

R¹ₓR²₃₋ₓSi-A (2)

wherein
R¹ is independently selected from non-hydrolyzable residues, preferably hydrocarbyl groups, more preferably alkyl groups, most preferably R¹ is methyl,
R² is independently selected from hydrolyzable residues, preferably selected from the group of consisting of hydrogen, hydroxy, hydrocarbylcarbonyloxy groups, such as acyloxy groups, halogen groups, amino groups, hydrocarbyloxy groups, such as alkoxy or aryloxy groups, more preferably alkoxy groups,
x is 0, 1 or 2, and
A is a group of the formula

-M-F,

wherein
M is selected from L or a group of the formula:

-{L-[SiR¹₂O]ₚ—SiR¹₂}ₘ-L-, wherein

L is independently selected from the group consisting of divalent alkylene groups having at least two carbon atoms, which can be interrupted by one or more —O—, —NR³—C(O)—, and/or —NR³—, —OC(O)NR³—, —NR³—C(O)—NR³— moieties, and can be substituted by one or more OH groups, wherein R³ is hydrogen, Me₃Si— or C1-C8-alkyl, preferably L is a divalent C2-C12-alkylene group, more preferably a divalent C2-C4 alkylene group, most preferably L is —(CH₂)₂— and/or —(CH₂)₃—,
R¹ is as defined above,
p=1 to about 9, preferably p=1 or 4, more preferably p=4,
m=1 to about 20, preferably m=1,
and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups

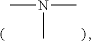

or quaternary ammonium groups

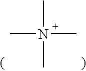

and may be substituted by OH groups, SH groups, halide groups, organosilyl groups or triorganosiloxy groups,
with the proviso that for the silanes of formula (2)
(i) A is a group of the formula
   -{L-[SiR¹₂O]ₚ—SiR¹₂}ₘ-L-F, wherein L, R¹, p, m and F are as defined above,
or
(ii) A is a group of the formula
   -L-F, wherein L contains at least one ether group (—O—), and optionally has at least one hydroxy substituent (—OH), and wherein F is as defined above with the proviso that it comprises at least one ester group (—O—C(═O)— or —C(═O)—O—).

### DETAILED DESCRIPTION OF THE INVENTION

The present invention generally relates to silica particles functionalized with one or more silanes. According to the invention, the term “silica particles” refers to particles of silicon dioxide, including but not limited to particles of colloidal silica or particles of fumed silica. In general, the silica particles according to the invention may have a D₅₀ average primary particle size of about 1 to about 300 nm, preferably of about 1 to about 150 nm, more preferably of about 5 to about 50 nm, and if agglomerates are formed, a D₅₀ average agglomerate particle size of about 1 to about 800 μm, preferably from about 5 to about 600 μm, more preferably from about 5 to about 400 μm; even more preferably from about 5 to about 200 μm, still more preferably from about 5 to about 150 μm; and most preferably from about 5 to about 75 μm. The silica particles may, without limitation thereto, comprise fumed (i.e. pyrogenic) silica or precipitated silica, and include crystalline or amorphous silica particles. In an embodiment, the silica particles are preferably particles of fumed silica.

According to the invention, the particles sizes may be determined by measuring the average particle size D₅₀ in particular, by laser ‘Dynamic Light Scattering with a Malvern Zetasizer, a method which is also known as photon correlation spectroscopy or quasi-elastic light scattering following ISO 13320-1 (see also http://en.wikipedia.org/wiki/Dynamic_light_scattering). Although this method is the determination method of choice, in particular in a non-cured composition, in certain instances it may also be sufficient to determine the average particle size D₅₀ by transmission electron microscopy (TEM).

According to the invention, the term “functionalized” indicates that the silica particles are modified by contacting them with one or more functionalized silanes, resulting in an alteration of the particles' properties due to the presence of other functional groups on the particles' surface relative to the particles' properties before the functionalization. Typically, the functionalization of silica particles by silanes takes place by formation of siloxane units via a condensation reaction of a silane or organosilyl ether and one or more OH groups present on the surface of the silica particle. According to this mode of functionalization, the silane comprises one or more hydrolysable groups on the silicon atom, for instance a chloro group.

According to an embodiment of the invention, a number of hydrolysable groups R² is defined which can be present in the silanes of the formula (2), for example alkoxy groups or acyloxy groups, which are prone to undergo condensation reactions with the silanol SiOH groups present on the silica surface. In a similar manner, the assumed mechanism for the functionalization of silanol SiOH groups on the silica surface by the disilazanes of formula (1) involves the initial hydrolysis of the silazane group by water present in the system or added to the reactive system, leading to silanol-functionalized silanes. Those silanol groups of the silane can condense with silanol groups present at the silica surface. By the formation of silyl ethers terminated by the silyl-based structures as defined in formula (1) and (2), diverse functional groups can be installed at the silica particle surface, rendering the particles hydrophobic, hydrophilic, coating matrix-reactive or providing other further properties as desired to the particles.

According to the invention, the group R¹ is independently selected from non-hydrolyzable residues, preferably hydrocarbyl groups, more preferably alkyl groups, most preferably R¹ is methyl. Herein, the term “non-hydrolysable” indicates that the group cannot be easily cleaved by the addition of water, hydroxide anions or, in full analogy thereto, by addition of an alcohol or alkoxide anions, in particular under acidic or basic conditions. The term “non-hydrolysable”indicates that the groups are preferably bonded to the silicon atom by a C—Si bond, and accordingly the non-hydrolyzable group is preferably an organyl group.

According to the invention, the non-hydrolysable R¹ group is preferably an optionally fluorinated hydrocarbyl group, which may be selected from the group consisting of alkyl groups, alkenyl groups, alkynyl groups, alkaryl groups, aralkyl groups and aryl groups, for instance phenyl, benzyl or tolyl groups, in particular from such groups having 1 to about 22 carbon atoms.

More preferably, the non-hydrolysable R¹ group is selected from alkyl groups, which may be selected from the group consisting of unsubstituted linear, branched and cyclic alkyl groups or groups combining linear and cyclic alkyl motifs, or structures combining branched and cyclic structures, in particular from linear C1-C22 alkyl groups such as methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and from cyclic C3-C22 alkyl groups, such as cyclopropyl, cyclobutyl, cyclopentyl, cyclohexyl and cycloheptyl groups.

Even more preferably, the non-hydrolysable group R¹ is selected from methyl, ethyl, isopropyl, tert-butyl, cyclopentyl or cyclohexyl groups, most preferably R¹ is methyl.

According to the invention, the group R² is independently selected from hydrolyzable residues, preferably selected from the group consisting of hydrogen, hydroxy, hydrocarbylcarbonyloxy groups, such as acyloxy groups, halogen groups, amino groups, hydrocarbyloxy groups, such as alkoxy or aryloxy groups, more preferably alkoxy groups.

Herein, the term “hydrolysable” indicates that the group can be easily cleaved by the addition of water, hydroxide anions or by the addition of an alcohol or alkoxide anions, in case of water or alcohols in particular under acidic or basic conditions. The term “hydrolysable” shall indicate that the groups are not bonded to the silicon atom by a C—Si bond, but by a Si—X bond, wherein X is Cl, Br or I, an Si—O bond, as is the case when R² is selected from hydroxy, hydrocarbylcarbonyloxy and hydrocarbyloxy groups, an Si—N bond, an Si—S bond or an Si—H bond.

According to the invention, the hydrolysable group R² is preferably independently selected from the group consisting of hydrogen, a hydroxyl group, a hydrocarbylcarbonyloxy group, wherein the hydrocarbyl residue can represent alkyl groups, alkenyl groups, alkynyl groups, alkaryl groups, aralkyl groups and aryl groups, in particular linear C1-C22 alkyl groups such as methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and cyclic C3-C22 alkyl groups such as cyclopropyl, cyclobutyl, cyclopentyl, cyclohexyl and cycloheptyl groups, a hydrocarbyloxy group, wherein the hydrocarbyl residue can represent alkyl groups, alkenyl groups, alkynyl groups, alkaryl groups, aralkyl groups and aryl groups, in particular linear C1-C22 alkyl groups such as methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and cyclic C3-C22 alkyl groups such as cyclopropyl, cyclobutyl, cyclopentyl, cyclohexyl and cycloheptyl groups, a halogen group, and an amino group, which comprises primary, secondary and tertiary amino groups.

More preferably, the hydrolysable group R² is an alkoxy group, even more preferably a group selected from methoxy, ethoxy, n-propoxy, n-butoxy, n-pentoxy, n-hexoxy, iso-propoxy, iso-butoxy, tert-butoxy, neo-pentoxy, cyclopentoxy or cyclohexoxy groups, still more preferably an methoxy, ethoxy or isopropoxy group, most preferably a methoxy group.

According to the invention, in formula (2) x is 0, 1 or 2, preferably x is 0 or 1, most preferably x is 0. Silanes bearing three hydrolysable groups have been demonstrated to be applied in the functionalization of silica particles beneficially and can be prepared conveniently.

As defined above, according to the invention A is a group of the formula

-M-F,

wherein M is selected from L or a group of the formula:

-{L-[SiR¹₂O]ₚ—SiR¹₂}ₘ-L-.

L is independently selected from the group consisting of divalent alkylene groups having at least two carbon atoms, which can be interrupted by one or more —O—, —NR³—C(O)—, and/or —NR³—, —OC(O)NR³—, —NR³—C(O)—NR³— moieties, and can be substituted by one or more OH groups, wherein R³ is hydrogen, Me₃Si- or C1-C8-alkyl.

According to the invention, L is preferably independently selected from the group consisting of divalent C2-C12-alkylene groups, which includes linear divalent C2-C12 alkylenes such as ethylene, n-propylene, n-butylene, n-pentylene, n-hexylene, n-heptylene, n-octylene, n-nonylene and n-decylene, branched divalent C2-C12 alkylenes such as iso-propylene, iso-butylene, tert-butylene, iso-pentylene, neo-pentylene, methylpentylene, methylhexylene, ethylhexylene, methylheptylene, ethylheptylene, methyloctylene and ethyloctylene, and cyclic divalent C2-C12 alkylenes such as cyclopentylene, cyclohexylene and cycloheptylene.

More preferably, L is independently selected from the group consisting of divalent C2-C4 alkylene groups, such as ethylene, n-propylene, n-butylene, iso-propylene, iso-butylene and tert-butylene, and most preferably L is independently selected from —(CH₂)₂— and/or —(CH₂)₃—, i.e. an ethylene group or an n-propylene group.

According to the invention, R¹ in the formula -{L-[SiR¹₂O]ₚ—SiR¹₂}ₘ-L-is as defined above,

and preferably R¹ in the formula

-{L-[SiR¹₂O]ₚ—SiR¹₂}ₘ-L-

is a saturated hydrocarbon substituent selected from the group consisting of a monovalent C1 to C22-alkyl, optionally substituted by one or more fluoro substituents, a C6-C22-aryl, a C8-C22-polycyclic aryl, a C7-C22-alkylaryl, and a C7-C22-arylalkyl group, more preferably R¹ in the formula

-{L-[SiR¹₂O]ₚ—SiR¹₂}ₘ-L-

is selected from the group consisting of methyl, 3,3,3-trifluoropropyl, phenyl, styryl, phenylpropyl, and naphthyl, even more preferably R¹ therein is selected from methyl, phenyl, 3,3,3-trifluoropropyl, most preferably R¹ in the formula

-{L-[SiR¹₂O]ₚ—SiR¹₂}ₘ-L-

is methyl.

According to the invention, p=1 to about 9, and preferably p=1 to 4, more preferably p=4. This is to be understood the way that the average of the indices p of the silanes of the formula (1) and/or (2) applied for the functionalization of the silica particles is within the range from 1 to about 9, including these endpoints, wherein it is preferred that the average is within the range from 1 to 4, including these endpoints, and most preferably the average of the indices p is 4.

According to the invention, it is further preferred when p is 1 to about 9, wherein the indices p for all silanes of the formula (1) and/or (2), which are applied for the functionalization of the silica particles are integers from the range of 1 to 9, i.e. 1, 2, 3, 4, 5, 6, 7, 8 or 9, more preferably the indices p are integers from the range of 1 to 4, i.e. 1, 2, 3 and 4, and most preferably p is 4.

This corresponds to a range from disiloxane blocks to decasiloxane blocks present in the group M represented by the formula

-{L-[SiR¹₂O]ₚ—SiR¹₂}ₘ-L-.

Setting the parameter p to 4 corresponds to the presence of pentasiloxane blocks in the group M. A precursor for such blocks is HMe₂Si—O—[Me₂SiO]₃—SiMe₂H, which can be conveniently synthesized by a non-equilibrating reaction of hexamethylcyclotrisiloxane and HMe₂Si—O—SiMe₂H (for example, according to e.g. JP 11158188 B, which is incorporated by reference in its entirety herein) already in high purity. After an additional distillation a pentasiloxane content of more than 90 weight-% according to gas chromatography is achievable. The aforementioned process for the synthesis of the non-equilibrated polyorganosiloxanes is applicable also for other tetraorganodisiloxanes and hexaorganocyclotrisiloxanes than hexamethylcyclotrisiloxane and HMe₂Si—O—SiMe₂H.

According to the invention, m=1 to about 20, preferably 1 to about 10, even more preferably 1 to 5, most, preferably m=1.

This is to be understood the way that the average of the indices m of the silanes of the formula (1) and/or (2) applied for the functionalisation of the silica particles is within the range from 1 to about 20, including these endpoints, wherein it is preferred that the average of m is within the range from 1 to about 10, including these endpoints, it is even more preferred that the average of m is within the range from 1 to 5, including these endpoints, and most preferably the average of the indices m is 1.

According to the invention, it is further preferred when m is 1 to about 20, wherein the indices m for all silanes of the formula (1) and/or (2), which are applied for the functionalization of the silica particles are integers from the range of 1 to 20, i.e. 1, 2, 3, 4, 5, 6, 7, 8, 9, 10, 11, 12, 13, 14, 15, 16, 17, 18, 19 and 20, more preferably the indices m are integers from the range of 1 to 10, more preferably the indices m are integers from the range of 1 to 5, and most preferably m is 1.

While groups M having a single siloxane block, i.e. with m=1, are preferred according to the invention, polyorganosiloxanes having up to about 20, in particular having 2, 3, 4 or 5 siloxane blocks linked together over divalent groups L as defined above, i.e. m=up to about 20, in particular m=2, 3, 4 or 5, are synthesized by a stepwise addition reaction of symmetrically substituted and asymmetrically substituted siloxane blocks, preferably di-, penta- or decasiloxane blocks, most preferably pentasiloxane blocks.

According to the invention, the group A is terminated by the group —F, which is bonded to the group M as described above.

According to the invention, F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups

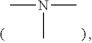

and quaternary ammonium groups

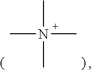

and may be substituted by OH groups, SH groups, halide groups, organosilyl groups and triorganosiloxy groups.
In the functionalization of the silica particles, the nature of the group F has a significant influence on the properties of the modified silica surfaces, as the terminal group F and its mode of functionalization decide whether the particles are overall hydrophobic, hydrophilic or which other properties they display. In particular, by the presence of reactive functional groups the group F can interact and bond to other components of a composition and can thus be linked to the polymer matrix of a cured composition.

In line with the above definition of F according to the invention, F may be preferably selected from the group consisting of C8-C22-alkylarylalkyl, C6-C22-aryl ether, C6-C22-cycloalkyl, C7-C22-cycloalkylalkylene, C7-C22-bicycloalkyl, C5-C12-hetero-N, -O, -aryl, C1-C20-alkyl aldehydes and C7-C20-alkylaryl aldehydes, all of these groups optionally substituted by C1-C8-alkyl, OH, Cl, or Br, and a silyl ether group R¹₃Si—O—, wherein R¹ is as defined above for formula (1) and (2), and wherein R¹ is preferably a C1-C8 alkyl group, most preferably a methyl group, and F may be preferably selected from the group consisting of a poly(C2-C4-alkylene) oxides, which can be OH- or C1-C8 oxyalkyl- or C1-C8 oxycarbonyl alkyl-terminated, F may be preferably selected from vinyl, allyl, hexenyl, octenyl, allyloxypropyl, —CH₂C≡CH, —C(O)C≡CH, —C(O)(CH₂)₈CH═CH₂, cyclohexenylethyl, limonyl, norbornenylethyl, vinylphenylethyl, allyloxyphenyloxypropyl, —(OCH₂CH₂O)ₐ—(OCH₂CH(CH₃))_{b}—(OCH₂CH₂CH(CH₃))_{c}—OCH═CH₂, or —(OCH₂CH₂)ₐ—(OCH₂CH(CH₃))_{b}—(OCH₂CH₂CH(CH₃))_{c}—OH, —(OCH₂CH₂)ₐ—(OCH₂CH(CH₃))_{b}—(OCH₂CH₂CH(CH₃))—O—C1-C4 alkyl, or —(OCH₂CH₂)ₐ—(OCH₂CH(CH₃))_{b}—(OCH₂CH₂CH(CH₃))_{c}—O—C(O)—C1-C4 alkyl, with a, b, c being 0 to 20 and a+b+c=1 to 20,

—[Si(CH₃)₂OSi(CH₃)₂]CH═CH₂, and

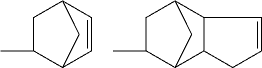

and in formula (2) F may be (X)ₓR¹₃₋ₓSi—, wherein R¹ is as defined above for formula (1) and (2), x=1-3, and X is ═OH, OR¹, —NR¹₂, R¹—C(O)—O—;
F in formula (1) and formula (2) may further be preferably selected from unsubstituted or substituted oxyphenyl moieties of the formula

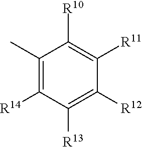

wherein R¹⁰, R¹⁴ is hydrogen or R¹ as defined for formula (1) or (2), and R¹¹, R¹², R¹³ are selected from —OR with R=H or C1-C8 alkyl,
wherein at least one of the groups R¹¹ to R¹³ is OH, and F may be preferably selected from from eugenolyl, bisphenolether, cumylphenolether, or glycidylpropylether radicals, epoxylimonyl, epoxycyclohexaneethyl, epoxynorbornyl,

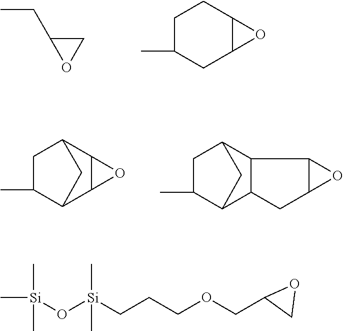

and the carbonate derivatives of these epoxides, tetrahydro-2H-thiopyranyl, carbazol, indol, trisphenylsilyl, and R⁶Me₂Si—, wherein R⁶=C6-C10-aryl, C7-C12-arylalkyl, C6-C12-cycloalkyl, C7-C16-bicycloalkyl, C6-C12-cyclothioalkyl, C5-C12-N- or C5-C12-O-aryl, optionally substituted by C1-C8-alkyl, OH, Cl, CN, and a silyl ether group R₃Si—O—,
F may be preferably selected from phenyl, phenylpropyl, styryl, naphthyl, eugenol, bisphenolether, cumylphenolether, norbornyl, vinyl, allyl, allyloxypropyl, hexenyl, norbornenyl, cyclohexenylethyl, limonyl, and glycidylpropylether, epoxylimonyl, epoxycyclohexaneethyl, epoxynorbornyl, and the carbonate derivatives of these epoxides,
(X)ₓR¹₃₋ₓSi— or R⁶ₓR¹₃₋ₓSi—, wherein x=1-3, wherein X is ═OH, OR¹, —NR¹₂—, R¹—C(O)—O— and wherein R₆=phenyl, naphthyl, phenylethyl, phenylpropyl, eugenol, limonyl, epoxylimonyl, glycidylpropylether epoxycyclohexylethyl, norbornenylethyl, epoxy norbornenylethyl, carbazol, indole. Therein, above-cited hydrocarbyloxysilyl groups and hydrocarbylcarbonyloxysilyl groups cannot constitute F in the compounds of the formula (1).

According to the invention, the group F preferably represents C1-C24 unsubstituted alkyl groups, specifically linear C1-C24 alkyl groups, C2-C24 alkylene oxide and poly(alkylene oxide) groups, wherein the alkylene oxide units are ethylene oxide units, propylene oxide units or a combination of these units, C2-C24 oxycarbonylhydrocarbyl groups, in particular C2-C24 oxycarbonylalkyl groups, C1-C24 oxyalkyl groups, C1-C24 alkanoyl groups, or C1-C24 alkanoyl ester groups, wherein the alkoxide group of the alkanoyl ester group is a C1-C12 alkoxide group.

Therein, F preferably represents C1-C24 unsubstituted alkyl groups selected from the group consisting of methyl, ethyl, n-propyl, n-butyl, n-pentyl, n-hexyl, n-hexyl, n-heptyl, n-octyl, n-nonyl, n-decyl, n-undecyl or n-dodecyl groups, in particular methyl and ethyl groups. Unsubstituted hydrocarbon groups, in particular unsubstituted alkyl groups are highly unpolar, i.e. hydrophobic functional groups and accordingly functionalization of the silica particles with silanes of the formula (1) and/or (2) wherein the group F is as described renders the particles hydrophobic.

According to the invention, when the group F represents C2-C24 poly(alkylene oxide) groups, it preferably represents poly(ethylene oxide) groups with about 2 to about 12 ethylene oxide repeating units, or poly(propylene oxide) groups with about 2 to about 8 propylene oxide repeating units. Therein, the poly(alkylene oxide) groups are preferably terminated by an OH group, by a methoxy group, or by a trimethylsiloxy group.

More preferably, the poly(alkylene oxide) groups represented by F are selected from residues of the structure —(O—CH₂CH₂)_{z1}—OH, wherein z1 is in the range of about 3 to about 12, even more preferably of about 5 to about 11, and even further preferably in the range of about 6 to about 10.5.
Therein, z1 refers to the average number of the repeating unit (O—CH₂CH₂) contained in the group F of the silanes of the formula (1) and/or (2) containing at least one of these repeating units; however, most preferably z1 is an integer in the range of about 3 to about 12, more preferably of about 5 to about 11, and even more preferably in the range of about 6 to about 10.
Also more preferably, the poly(alkylene oxide) groups represented by F are selected from residues of the structure —(O—CH₂CH₂)_{z2}—OMe, wherein z2 is in the range of about 3 to about 12, even more preferably of about 5 to about 11, and even further preferably in the range of about 6 to about 10.5.
Therein, z2 refers to the average number of the repeating unit (O—CH₂CH₂) contained in the group F of the silanes of the formula (1) and/or (2) containing at least one of these repeating units; however, most preferably z2 is an integer in the range of about 3 to about 12, more preferably of about 5 to about 11, and even more preferably in the range of about 6 to about 10.
Likewise more preferably, the poly(alkylene oxide) groups represented by F are selected from residues of the structure —(O—CH₂CH₂)_{z3}—OSiMe₃, wherein z3 is in the range of about 3 to about 12, more preferably of about 5 to about 11, and even more preferably in the range of about 6 to about 10.5.
Therein, z3 refers to the average number of the repeating unit (O—CH₂CH₂) contained in the group F of the silanes of the formula (1) and/or (2) containing at least one of these repeating units; however, most preferably z3 is an integer in the range of about 3 to about 12, more preferably of about 5 to about 11, and even more preferably in the range of about 6 to about 10.
Most preferably, the poly(alkylene oxide) groups represented by F are selected from the group consisting of —(O—CH₂CH₂)₇—OH, —(O—CH₂CH₂)₈—OH, —(O—CH₂CH₂)₉—OH, —(O—CH₂CH₂)₁₀—OH, —(O—CH₂CH₂)₁₁—OH, —(O—CH₂CH₂)₁₂—OH, —(O—CH₂CH₂)₇—OMe, —(O—CH₂CH₂)₈—OMe, —(O—CH₂CH₂)₉—OMe, —(O—CH₂CH₂)₁₀—OMe, —(O—CH₂CH₂)₁₁—OMe, —(O—CH₂CH₂)₁₂—OMe, —(O—CH₂CH₂)₇—OSiMe₃, —(O—CH₂CH₂)₈—O SiMe₃, —(O—CH₂CH₂)₉—O SiMe₃, —(O—CH₂CH₂)₁₀—O SiMe₃, —(O—CH₂CH₂)₁₁—O SiMe₃, and —(O—CH₂CH₂)₁₂—SiMe₃.
Poly(alkylene oxide) groups in F render the silane residues attached to the silica particles' surface polar, i.e. hydrophilic, and thus the silica particles' surface is rendered hydrophilic by such functionalization. It is particular preferred when the poly(alkylene oxide) group is terminated by an OH group, a methoxy group or a trimethylsiloxy group.

When the group F represents C2-C24 oxycarbonylalkyl groups, according to the invention it is preferred when the alkyl group of the oxycarbonyl group is selected from the group consisting of methyl, ethyl n-propyl, n-butyl, n-pentyl, n-hexyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and cyclic C3-C22 alkyl groups such as cyclopropyl, cyclobutyl, cyclopentyl, cyclohexyl and cycloheptyl groups. It is also preferred according to the invention when the alkyl group of the oxycarbonylalkyl group is bonded to the oxycarbonyl group by a carbon atom substituted with three C1-C8 alkyl substituents. Therein, it is particularly preferred when the sum of carbon atoms of all three alkyl substituents is about 10 or less, and even more preferred when one of the alkyl substituents is a methyl group and the sum of carbon atoms of the two further alkyl substituents is about 8 or less.

When the group F represents a C1-C24 oxyalkyl group, according to the invention the alkyl group of the C1-C24 oxyalkyl group is preferably selected from the group consisting of methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and cyclic C3-C22 alkyl groups such as cyclopropyl, cyclobutyl, cyclopentyl, cyclohexyl and cycloheptyl groups.

When the group F represents a 01-C24 alkanoyl group, according to the invention the C1-C24 alkanoyl group is preferably selected from the group consisting of the carboxylic acid residues —COOH, —CH₂CO₂H, —(CH₂)₂CO₂H, —(CH₂)₃CO₂H, —(CH₂)₄CO₂H, —(CH₂)₅CO₂H, —(CH₂)₆CO₂H, —(CH₂)₇CO₂H, —(CH₂)₇CO₂H, —(CH₂)₉CO₂H, or (CH₂)₁₀CO₂H.

When the group F represents a C1-C24 alkanoyl ester group, wherein the alkoxy group of the alkanoyl ester group is a C1-C12 alkoxy group, according to the invention the alkanoyl group is preferably selected from the group consisting of the alkanoyl residues —CO, —CH₂CO, —(CH₂)₂CO, —(CH₂)3C, —(CH₂)₄CO, —(CH₂)₅CO, —(CH₂)₆CO, —(CH₂)₇CO, —(CH₂)₇CO, —(CH₂)₉CO, or (CH₂)₁₀CO, and the alkoxy group of the ester is preferably selected from methoxy, ethoxy, n-propoxy, iso-propoxy, n-butoxy, iso-butoxy, tert-butoxy, n-pentoxy, iso-pentoxy, neo-pentoxy or n-hexoxy groups.

Particularly preferred alkanoyl ester groups according to the invention are selected from the group consisting of —COOMe, —COOEt, —COOtBu, —CH₂CO₂Me, —CH₂CO₂Et, —CH₂CO₂tBu, —(CH₂)₂CO₂Me, —(CH₂)₂CO₂Et, —(CH₂)₂CO₂tBu, —(CH₂)₃CO₂Me, —(CH₂)₃CO₂Et, —(CH₂)₃CO₂tBu, —(CH₂)₄CO₂Me, —(CH₂)₄CO₂Et, —(CH₂)₄CO₂tBu, —(CH₂)₅CO₂Me, —(CH₂)₅CO₂Et, —(CH₂)₅CO₂tBu, —(CH₂)₆CO₂Me, —(CH₂)₆CO₂Et and —(CH₂)₆CO₂tBu, wherein Bu=butyl, tBu=tert-butyl, Me=methyl, and Et=Ethyl.

According to the invention, the group F preferably contains one or more coating-matrix-reactive groups, which are functional groups able to interact or bond with the polymer matrix of the coating matrix before, during or after curing of a curable composition. These groups may be any kind of group capable of interacting with the coating polymer matrix or its precursors, in particular functional groups selected from the group consisting of alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy, 1,3-dicarboxy, diesters, 1,3-diesters, nitro (—NO₂), cyano (—CN), alkyl sulfonyl fluoride-groups, as well as donor and acceptor groups in the Michael addition reaction which are incorporated into the polymer matrix by formation of covalent bonds.

According to the invention, the above given definitions describe the invention under the proviso that for the silanes of formula (2)
(i) A is a group of the formula
   -{L-[SiR¹₂O]ₚ—SiR¹₂}ₘ-L-F, wherein L, R¹, p, m and F are as defined above,
or
(ii) A is a group of the formula
   -L-F, wherein L contains at least one ether group (—O—), and optionally has at least one hydroxy substituent (—OH), and wherein F is as defined above with the proviso that it comprises at least one ester group (—O—C(═O)— or —C(═O)—O—).

In a preferred embodiment according to the invention, the silica particles are functionalized with one or more silanes of the formula (1) and/or formula (2), wherein one or more of the silanes of the formula (1) and/or (2) contain one or two groups A comprising a group M of the formula

-{—[SiR¹₂O]ₚ—SiR¹₂}ₘ-L-

with L, R¹, p, and m as defined above,
wherein the group or groups M of the formula -{L-[SiR¹₂O]ₚ—SiR¹₂}ₘ-L-
are composed of one or more defined polysiloxane blocks consisting essentially either of a disiloxane, a polyorganopentasiloxane, or polyorganodecasiloxane block, wherein the term “consisting essentially of” means that more than about 50% by number of the groups M according to this embodiment have the same chain length, wherein the index p in the above formula is p=1, 4, or about 9.
It is clear that herein p cannot refer to an average value, but refers to a distinct value of p being an integer selected from 1, 4 or about 9.

In a further preferred embodiment according to the invention, more than about 80% by number of the groups M of the formula

-{L-[SiR¹₂O]ₚ—SiR¹₂}ₘ-L-with L, R¹, and mas defined above, have an index of p of exclusively 1, or of exclusively 4, or of exclusively about 9.
Particularly preferred more than about 90% by number of the groups M of the formula
-{L-[SiR¹₂O]ₚ—SiR¹₂}ₘ-L-with L, R¹, and m as defined above, have an index of p of exclusively 1, or of exclusively 4, or of exclusively about 9.
Such high degree of a uniform group M having a polydispersity index close to about 1 can be achieved by the purification process for the precursors according to the invention. It is therefore stated to have groups M with a monomodal chain length distribution.
This feature can be achieved since the precursors, i.e., compounds like disubstituted tetraorganodisiloxanes, hexaorganocyclotrisiloxanes and their reaction product of the non-equilibrated reaction, have distinct boiling points and can be enriched respectively purified, e.g., by distillation or crystallization in each of the following steps of the addition of the terminal groups.
For example, one of the preferred pentasiloxane units with p=4 can be derived from HMe₂Si—O—[Me₂SiO]₃—SiMe₂H which is synthesized by a non-equilibrating reaction of hexamethylcyclotrisiloxane and HMe₂Si—O—SiMe₂H (for example according to JP 11158188 B) already in high purity. After an additional distillation a pentasiloxane content of more than about 90 weight-% according to gas chromatography is can be achieved.

The aforementioned process for the synthesis of the non-equilibrated polyorganosiloxanes is applicable also for other di-substituted tetraorganodisiloxanes, and hexaorganocyclotrisiloxanes.

The purified pentasiloxane having the structure M*^{H}D₃M*^{H}′, wherein “M*H” represents a hydride-substituted siloxane mono-unit of the structure, is submitted to the addition of further compounds comprising reactive groups which can undergo a hydrosilylation reaction with the terminal SiH units. The reagents applied for the introduction of the L groups therefore need to be functionalized suitably to undergo a hydrosilylation step with the siloxane hydride, for example by comprising a terminal C—C double bond. The reagents used for hydrosilylation j may further already fully comprise the groups F, and the silane structures bonded to A on the other terminus of M, respectively. For example, by reacting one terminus of a precursor of the formula (3a) with an allyl-terminated polyether in a hydrosilylation reaction, and reacting thus obtained intermediate with (MeO)₃SiVi in a hydrosilylation reaction, a compound of the formula (2) is obtained wherein the silane terminus bears three hydrolysable methoxy groups, the first L group linking the silane moiety to the polysiloxane moiety is an ethylene group, the L group linking the polysiloxane group to the group F is a propylene group, and F is a polyether group.

The compounds of the formula (1) and/or (2) used for the functionalization of the silica particles according to the invention can be derived from any suitable polyorganosiloxane as a starting material which provides symmetrically reactive substituents at the terminal groups. Particularly suitable polyorganosiloxanes include, but are not limited to:

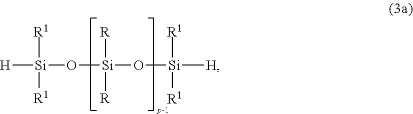

wherein L and R¹ are as defined above for the formula -{L-[SiR¹₂O]ₚ—SiR¹₂}ₘ-L-F.

In a preferred embodiment, the substituents of the polyorganosiloxane moieties of the precursors as represented by the formula (3a) are defined as follows: R is independently selected from methyl, 3,3,3-trifluoropropyl, phenyl, styryl, phenylpropyl, naphthyl, and R¹ is as defined above, preferably methyl.

In still a further preferred embodiment according to the invention, less than 60% by number of the groups M of the formula

-{L-[SiR¹₂O]ₚSiR¹₂}ₘ-L with L, R¹, and m as defined above, and particularly preferred less than 50% by number of the groups M of the formula -{L-[SiR¹₂O]ₚ—SiR¹₂}ₘ-L-with L, R¹, and m as defined above have the same chain length, wherein the number average of the indices p is in the range from about 2 to about 8, more preferably from about 3 to about 7, most preferably from about 3.5 to about 6.5.

All subscripts indicating a range of repeating numbers of repeating units in an oligo- or poly(alkylene oxide) or an oligo- or polysiloxane structural unit in general refer to average values obtained for the silanes of the formula (1) and/or (2) applied for the functionalization of silica particles that contain at least one of the respective repeating unit. This is due to the fact that starting materials for the provision of such structural motifs are often mixtures defined by an average chain length; however, it is generally preferred that the subscripts refer to integers from the given range, i.e. the number of repeating units is within the indicated range in all silanes of the formula (1) and/or (2) applied for the functionalization of silica particles that contain one or more of the respective repeating units as indicated.

In a preferred embodiment according to the invention, silica particles are provided wherein in formula (1), when M is L, then the group F contains at least one heteroatom, such as N, O, P, S, Si, or a halogen atom, such as fluorine, chlorine, bromine or iodine.

Preferably, silica particles are provided wherein in formula (1) M is L, and the group F contains at least one heteroatom, such as N, O, Si, or a halogen atom, such as fluorine or chlorine. More preferably, in the formula (1) M is L, and the group F contains one or more oxygen atoms, more preferably F contains one or more oxygen atoms wherein at least one oxygen atom is an oxygen atom of an ether or an ester moiety, even more preferably the group F contains three or more oxygen atoms wherein at least three oxygen atoms are oxygen atoms of an oligo- or poly(alkylene oxide) group, still more preferably the group F contains five or more oxygen atoms wherein at least five oxygen atoms are oxygen atoms of an oligo- or poly(alkylene oxide) group, and even more preferably the group F contains a poly(ethylene oxide) or a poly(propylene oxide) unit containing five or more oxygen atoms.
Most preferably, in the compound of the formula (1) M is L, and

F═—(O—CH₂CH₂)₄₋₁₂—H, or

F═—(O—CH₂CH₂)₄₋₁₂—OMe, or

F═—(O—CH₂CH₂)₄₋₁₂—OSiMe₃.

Compounds of the formula (1) according to this embodiment of the invention are for example the compounds represented by the formulas

HN(—SiMe₂-(CH₂)₂₋₃—(O—CH₂CH₂)₄₋₁₂—OH)₂, specifically

HN(—SiMe₂-(CH₂)₂—(O—CH₂CH₂)₁₀—OH)₂ and HN(—SiMe₂-(CH₂)₃—(O—CH₂CH₂)₁₀—OH)₂,

HN(—SiMe₂-(CH₂)₂₋₃—(O—CH₂CH₂)₄₋₁₂—OMe)₂, specifically

HN(—SiMe₂-(CH₂)₂—(O—CH₂CH₂)_{7.5}—OMe)₂ and HN(—SiMe₂-(CH₂)₃—(O—CH₂CH₂)_{7.5}—OMe)₂, or

HN(—SiMe₂-(CH₂)₂₋₃—(O—CH₂CH₂)₄₋₁₂—OSiMe₃)₂, specifically

HN(—SiMe₂-(CH₂)₃—(O—CH₂CH₂)₁₀—OSiMe₃)₂ and

HN(—SiMe₂-(CH₂)₃—(O—CH₂CH₂)₁₀—OSiMe₃)₂.

It is also preferred according to this embodiment that M is L, and F either contains or is an oxycarbonylalkyl group of the formula

—OC(O)-alkyl,

wherein the alkyl group is a linear, branched or cyclic C1-C12 alkyl group, preferably a linear alkyl group selected from methyl, ethyl, propyl, butyl, pentyl, hexyl, heptyl, octyl, nonyl or decyl group, or a branched alkyl group selected from iso-propyl, sec-butyl, tert-butyl, neo-pentyl or from an alkyl group of the formula —CR^{a}R^{b}R^{c},
wherein the residues R^{a}, R^{b} and R^{c} are selected from linear alkyl groups and hydrogen and two or more of R^{a}, R^{b} and R^{c} are alkyl groups, more preferably the alkyl group is a linear alkyl group selected from ethyl or methyl, or from the formula —CR^{a}R^{b}R^{c}, wherein R^{c} is hydrogen or methyl, and R^{a} and R^{b} are linear alkyl groups having 3 to about 11 carbon atoms in total.

Further compounds of the formula (1) according to this embodiment of the invention are for example the compounds represented by the formula

HN(—SiMe₂-(CH₂)₂₋₃—(O—C(O)alkyl))₂, specifically

HN(—SiMe₂-(CH₂)₂—(O—C(O)alkyl))₂ and HN(—SiMe₂-(CH₂)₃—(O—C(O)alkyl))₂, even more specifically HN(—SiMe₂-(CH₂)₂—(O—C(O)—CMeR^{a}R^{b}))₂ and HN(—SiMe₂-(CH₂)₃—(O—C(O)—CMeR^{a}R^{b}))₂, wherein R^{a} and R^{b} are linear alkyl groups and have a total number of C-atoms from 3 to about 9.

In an also preferred embodiment according to the invention, silica particles are provided wherein in formula (1) M is L, and the group F contains one or more silicon atoms, more preferably the group F contains one or more silicon atoms, wherein one of the silicon atoms is the silicon atom of a terminal triorganosilyl group, such as —SiMe₂-CH═CH₂, —SiMe₃, —SiEt₃, —Si(iPr)₃, —SiPh₃, —Si(cyHex)₃, —SitBuMe₂, —SitBuPh₂,—, even more preferably the terminal triorganosilyl group of F is selected from —SiMe₂-CH═CH₂, —SiMe₃ or —SiEt₃ and bonded to an oxygen atom, and still more preferably the terminal triorganosilyl group is selected from —SiEt₃ or —SiMe₃ and constitutes the end-capping group of a group selected from a poly(ethylene oxide) group, an poly(propylene oxide) group, or mixed poly(propylene oxide)-poly(ethylene oxide) group, or constitutes the terminal group of a C1-C12 linear alkyl group or a C1-C12 alkenyl group.

Most preferably, in the compound of the formula (1) M is L, and

F═—(O—CH₂CH₂)₄₋₁₂—OSiMe₃, or

F═—(O—CH₂CH₂CH₂)₄₋₁₂—OSiMe₃, or

F═—(O—CH₂CH₂)₄₋₁₂—OSiEt₃, or

F═—(O—CH₂CH₂CH₂)₄₋₁₂—OSiEt₃.

Compounds of the formula (1) according to this embodiment of the invention are for example the compounds represented by the formulas

HN(—SiMe₂-(CH₂)₂₋₃—(O—CH₂CH₂CH₂)₄₋₁₂—OSiMe₃)₂, specifically

HN(—SiMe₂-(CH₂)₂—(O—CH₂CH₂CH₂)₁₀—OSiMe₃)₂ and HN(—SiMe₂-(CH₂)₃—(O—CH₂CH₂CH₂)₁₀—OSiMe₃)₂, or

HN(—SiMe₂-(CH₂)₂₋₃—(O—CH₂CH₂)₄₋₁₂OSiEt₃)₂, specifically

HN(—SiMe₂-(CH₂)₂—(O—CH₂CH₂)_{7.5}—OSiEt₃)₂ and HN(—SiMe₂-(CH₂)₃—(O—CH₂CH₂)_{7.5}—OSiEt₃)₂, or

HN(—SiMe₂-(CH₂)₂₋₃—(O—CH₂CH₂CH₂)₄₋₁₂—OSiEt₃)₂, specifically

HN(—SiMe₂-(CH₂)₂—(O—CH₂CH₂CH₂)₁₀—OSiEt₃)₂ and HN(—SiMe₂-(CH₂)₃—(O—CH₂CH₂CH₂)₁₀—OSiEt₃)₂.

In another preferred embodiment according to the invention, silica particles are provided wherein in formula (1) the substituents of the hydrocarbyl radicals F are selected from the group consisting of hydroxyl, thiol, alkoxy, siloxy, perfluoroalkyl, carboxyl, ester, aminoalkyl, thioalkyl, or polyether groups, alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy, 1,3-dicarboxy, diesters, 1,3-diesters, nitro (—NO₂), cyano (—CN), alkyl sulfonyl fluoride groups, as well as donor and acceptor groups in the Michael addition reaction.

Preferably, the substituents of the hydrocarbyl radicals F are selected from hydroxyl groups, alkoxy groups, in particular methoxy, ethoxy, n-propoxy, iso-propoxy, n-butoxy, iso-butyoxy, tert-butoxy, n-pentoxy, iso-pentoxy, neo-pentoxy, n-hexoxy, cyclopentoxy or cyclohexoxy groups, siloxy groups, in particular —SiMe₂-O—SiMe₂-CH═CH₂, —OSiMe₃, —OSiEt₃, —OSi(iPr)₃, —OSiPh₃, —OSi(cyHex)₃, —OSitBuMe₂, —OSitBuPh₂, perfluoro alkyl groups, in particular trifluoromethyl, linear perfluoroalkyl groups of the general formula —CₓF₂ₓ₊₁ with x=2 to about 24, pentafluorophenyl, ester groups, in particular ester groups having the formulae —COOMe, —COOEt, —COOtBu, —CH₂CO₂Me, —CH₂CO₂Et, —CH₂CO₂tBu, —(CH₂)₂CO₂Me, —(CH₂)₂CO₂Et, —(CH₂)₂CO₂tBu, —(CH₂)₃CO₂Me, —(CH₂)₃CO₂Et, —(CH₂)₃CO₂tBu, —(CH₂)₄CO₂Me, —(CH₂)₄CO₂Et, —(CH₂)₄CO₂tBu, —(CH₂)₅CO₂Me, —(CH₂)₅CO₂Et, —(CH₂)₅CO₂tBu, —(CH₂)₆CO₂ Me, —(CH₂)₆CO₂Et and —(CH₂)₆CO₂tBu, and ester groups in which the alkoxy group is a tertiary C4-C25 alkoxy group, and polyether groups selected from the group of compounds represented by the formulae —(OCH₂CH₂)ₐ—(OCH₂CH(CH₃))_{b}—(OCH₂CH₂CH(CH₃))_{c}—OH, —(OCH₂CH₂)ₐ—(OCH₂CH(CH₃))_{b}—(OCH₂CH₂CH(CH₃))_{c}—O—C1-C4 alkyl, —(OCH₂CH₂)ₐ—(OCH₂CH(CH₃))_{b}—(OCH₂CH₂CH(CH₃))_{c}—O—C(O)—C1-C4 alkyl and —(OCH₂CH₂)ₐ—(OCH₂CH(CH₃))_{b}—(OCH₂CH₂CH(CH₃))_{c}—O—SiR₃, with R=C1-C8 alkyl, a, b, c being 0 to 20 and a+b+c=1 to 20; more preferably the hydrocarbyl radical F comprises at the same time both a polyether group and a terminal hydroxyl group, both a polyether group and a terminal alkoxy group, or a polyether group and a terminal siloxy group as defined above.

Also preferably, the substituents of the hydrocarbyl radicals F are selected from alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy, 1,3-dicarboxy, diesters, 1,3-diesters, nitro (—NO₂), cyano (—ON), alkyl sulfonyl fluoride groups, as well as donor and acceptor groups in the Michael addition reaction

It is particularly preferred when the hydrocarbyl radicals F comprise one or more groups of the structure —(OC(O)-alkyl, wherein the alkyl group is an alkyl group of the formula CMeR^{a}R^{b}, and wherein R^{a} and R^{b} are alkyl groups containing a total of 7 carbon atoms, or wherein R^{a} and R^{b} are alkyl groups containing a total of 6 carbon atoms, it is also particularly preferred when the hydrocarbyl radicals F comprise one or more polyether structures, preferably a polyether structure terminated by a OCH₃, OH or OSiMe₃ group, or when the hydrocarbyl group F comprises one or more butyl groups.

In yet another preferred embodiment according to the invention, silica particles are provided wherein F comprises at least one moiety selected from the group consisting of polyether moieties, ester moieties, and coating-matrix-reactive moieties, such as alkenyl, epoxy, acrylate, methacrylate, thiol, hydroxyl, alkoxy, carboxy (—COOH), amino and isocyanate groups, ketones, diketones, 1,3-diketones, dicarboxy, 1,3-dicarboxy, diesters, 1,3-diesters, nitro (—NO₂), cyano (—CN), alkyl sulfonyl fluoride groups, as well as donor and acceptor groups in the Michael addition reaction.

It is preferred that F comprises a polyether moiety providing hydrophilic properties to the functionalized silica particles, and it is also preferred that F comprises one or more coating-reactive moieties.

Preferred polyether moieties comprised by the group F are selected from the group of compounds represented by the formulae —(OCH₂CH₂)ₐ—(OCH₂CH(CH₃))_{b}—(OCH₂CH₂CH(CH₃))_{c}—OH, —(OCH₂CH₂)ₐ—(OCH₂CH(CH₃))_{b}—(OCH₂CH₂CH(CH₃))_{c}—O—C1-C4 alkyl, —(OCH₂CH₂)ₐ—(OCH₂CH(CH₃))_{b}—(OCH₂CH₂CH(CH₃))_{c}—O—C(O)—C1-C4 alkyl and —(OCH₂CH₂)ₐ—(OCH₂CH(CH₃))_{b}—(OCH₂CH₂CH(CH₃))_{c}—O—SiR₃, with R=C1-C8 alkyl, a, b, c being 0 to about 20 and a+b+c=1 to about 20, more preferred are groups represented by the formulas

—(OCH₂CH₂)₃₋₁₀—OCH₃, —(OCH₂CH₂)₃₋₁₀—OH and (OCH₂CH(CH₃))₃₋₁₀—OCH₃—, (OCH₂CH(CH₃))₃₋₁₀—OH.

The term “coating-matrix-reactive moiety” according to the invention relates to any functional moiety which interacts with the coating matrix by a reaction leading to the incorporation into the coating matrix during a polymerization or curing reaction of the coating composition, i.e. by the formation of covalent bonds. Therein, the coating matrix is defined as the polymeric scaffold formed by polymerization and/or curing of polymerizable and/or curable compounds present in the coating compositions.

The type of coating composition the functionalized particles are applied in therefore depends on whether a functional moiety is coating-matrix reactive or not. For instance, acrylate or methacrylate groups are coating-matrix-reactive compounds in a coating composition based on curable polyacrylates or polymethacrylates, an alkenyl group will be coating-matrix-reactive in a coating composition comprising a system suitable for radical polymerization of olefins or polyolefins, or in a composition comprising groups that can undergo ene-reactions, i.e. containing ene-ophilic groups, such as thiol or hydroxyl groups. Accordingly, a variety of functional groups can be considered to be coating-matrix-reactive, and the skilled person is well aware which functional groups are coating-matrix-reactive for a certain type of coating composition.

Most preferred according to the invention are coating matrix-reactive moieties such as alkenyl, epoxy, acrylate, methacrylate, thiol, hydroxyl, alkoxy, carboxy (—COOH), amino, alkoxysilyl and isocyanate, ketones, diketones, CH-acidic groups such as 1,3-diketones, 1,3-dicarboxy groups, 1,3-diesters, methylene nitro (—NO₂) groups, methylene nitrile groups, Michael donor and acceptor groups.

Preferred coating-matrix-reactive moieties selected from the group of alkenyl groups are linear or branched alkenyl groups having at least one terminal C—C double bond and cyclic C5- and C6-alkenyl groups, more preferred are linear or branched C2-C30 alkenyl groups having at least one terminal C—C double bond, even more preferred are C2-C30 linear or branched alkenyl groups having a single C—C double bond which is a terminal C—C double bond, and most preferred are vinyl, allyl, propenyl, butenyl, pentenyl, hexenyl, heptenyl and octenyl groups.

Preferred coating-matrix-reactive moieties selected from the group of epoxy groups are glycidyl groups and glycidyl oxy groups, in particular propylene glycidyl ether, phenylene glycidyl ether, C3-C12-epoxy alkyl, C6-C12-epoxy cycloalkyl, C7-C16-epoxy bicycloalkyl, epoxylimonyl, epoxycyclohexanethyl, epoxynorbornyl,

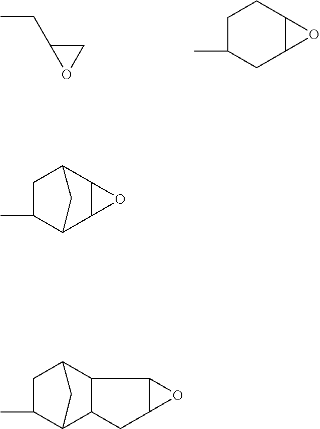

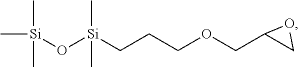 [SMILES: C[Si](C)(C)O[Si](C)(C)CCCOCC1CO1]

monoepoxypolyether groups or acetylenic-epoxy ether groups, e.g. propargyl glycidyl ether group, 1,4-butynediol-di-glycidylether groups, in general groups bearing terminal epoxide groups.

Preferred coating-matrix-reactive moieties selected from the group of amino groups include primary amino group —NH₂, secondary amino groups —NHR¹ and tertiary amino groups —NR¹₂, wherein R¹ is a C1-C8 linear, branched or cyclic alkyl group, and heterocyclic amino compounds, more preferred are —NH₂, NHMe, NHEt, NHnBu, —NHcyHex, —NMe₂, —NEt₂, and —NcyHex₂ (where cyHex is cyclohexyl).

Preferred coating-matrix-reactive moieties selected from the group of diketones are all kinds of alkyl groups containing a 1,3-diketone or 1,4-diketone moiety, more preferably a 1,3-diketone moiety.

Preferred coating-matrix-reactive moieties selected from the group of diesters are all kinds of alkyl groups containing a 1,3-diester or 1,4-diester moiety, more preferably a 1,3-diester moiety.

Further preferred coating-matrix-reactive moieties are moieties containing a β-diketo group, a β-ketoester group, a β-diester group or a C—H bond in α-position to a nitro group or to a nitrile group.

Preferred coating-matrix-reactive moieties are selected from the group of Michael donors consisting of thiolate, alkoxide, in particular phenolate, amine, and alkenyl, epoxy, acrylate, methacrylate, thiol, hydroxyl, alkoxy, carboxy (—COOH), amino and isocyanate groups, ketones, diketones, 1,3-diketones, dicarboxy, 1,3-dicarboxy, diesters, 1,3-diesters, nitro (—NO₂), cyano (—ON), alkyl sulfonyl fluoride groups, as well as acceptor groups in the Michael addition reaction. Therein, the thiolates and alkoxides are present in the silanes according to the invention as the corresponding thiols and alcohols under neutral conditions. Likewise, the carboxy groups may also be present as the corresponding carboxylate groups.

Preferred coating-matrix-reactive moieties selected from the group of Michael acceptor groups are α,β-unsaturated aldehyde groups, α,β-unsaturated keto groups, α,β-unsaturated ester groups, α,β-unsaturated amide groups and α,β-unsaturated nitrile groups, more preferred are α,β-unsaturated ester groups and amide groups, in particular α,β-unsaturated methyl ester groups and α,β-unsaturated ethyl ester groups, and α,β-unsaturated —C(O)NH₂, —C(O)NMe₂ and —C(O)NEt₂ groups. Further preferred coating-matrix-reactive moieties are esters of malonic acid, 1,3-diester moieties and 1,4-diester moieties.

In a further preferred embodiment according to the invention, silica particles are provided wherein F is selected from the group consisting of:
alkyl,
alkenyl,
alkylcarbonyloxy,
polyalkylene oxide groups, preferably of the general formula:

[—OC₂H₄]_{q}[—OC₃H₆]ᵣ[—OC₄H₈]ₛ—R⁴
wherein
[—OC₂H₄] represents an ethyleneoxy unit,
[—OC₃H₆] represents a propyleneoxy unit, and
[—OC₄H₈] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10, with q+r+s>2,
R⁴ is selected from the groups consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR¹₃, wherein R¹ is independently selected from the groups as defined above for formula (1) and (2), and siloxy groups such as —OSi(R¹)₃, wherein R¹ is independently selected from the groups as defined above for formula (1) and (2).

According to this embodiment of the invention, preferred alkyl groups from which the group F is selected are selected from the group consisting of linear, branched and cyclic alkyl groups or groups combining linear and cyclic alkyl motifs, or structures combining branched and cyclic structures, in particular from linear C1-C22 alkyl groups such as methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and from cyclic C3-C22 alkyl groups such as cyclopropyl, cyclobutyl, cyclopentyl, cyclohexyl and cycloheptyl groups. Most preferably, alkyl groups from which the group F is selected are selected from methyl, ethyl, isopropyl, tert-butyl, cyclopentyl or cyclohexyl groups, most preferably from methyl.

According to the this embodiment of invention, preferred alkenyl groups from which the group F is selected are selected from the group consisting of linear or branched alkenyl groups having at least one terminal C—C double bond and cyclic C5- and C6-alkenyl groups, more preferred are linear or branched C2-C30 alkenyl groups having at least one terminal C—C double bond, even more preferred are C2-C30 linear or branched alkenyl groups having a single C—C double bond which is a terminal C—C double bond, and most preferred are vinyl, allyl, propenyl, butenyl, pentenyl, hexenyl, heptenyl and octenyl groups.

According to this embodiment of the invention, preferred alkylcarbonyloxy groups from which the group F is selected are selected from the group consisting of alkylcarbonyloxy groups wherein the alkyl represents linear C1-C22 alkyl groups such as methyl, ethyl, n-propyl, n-butyl, n-pentyl, n-hexyl, n-heptyl or n-octyl groups, branched C1-C22 alkyl groups such as iso-propyl, iso-butyl, tert-butyl, iso-pentyl, tert-pentyl, neo-pentyl and 2-ethylhexyl groups, and cyclic C3-C22 alkyl groups such as cyclopropyl, cyclobutyl, cyclopentyl, cyclohexyl and cycloheptyl groups, and most preferably methyl, ethyl, tert-butyl groups and further branched alkyl groups comprising a tertiary carbon atom bonded to three linear C1-C8 alkyl groups, which is bonded to the carbonyloxy group.

According to this embodiment of the invention, it is preferred when F is selected from polyalkylene oxide groups of the general formula:

[—OC₂H₄]_{q}[—OC₃H₆]ᵣ[—OC₄H₈]ₛ—R⁴.

Therein, it is preferred when q+r+s is in the range of from 2 to about 15, and it is particularly preferred when q is in the range of 2 to about 15 while r and s=0, or r is in the range of 2 to about 15 while q and s=0, or s is in the range of 2 to about 15 while q and r=0.

It is also preferred when R⁴ is selected from the group consisting of hydroxyl, hydroxymethyl, hydroxyethyl, methoxy, ethoxy, n-propoxy, iso-propoxy, n-butoxy, iso-butoxy, tert-butoxy, methylcarbonyloxy, tert-butylcarbonyloxy, —OSiMe₃, —SiMe₂-O—SiMe₂-CH═CH₂, glycidoxy groups or —SiMe₃, SiPh₃, —SiEt₃, —SitBuMe₂, —SiMe₂Vinyl, or —SiMe₂Allyl. Therein, it is also preferred that if R₄ represents a glycidyl or glycidoxy group, the group is preferably selected from a glycidyl group, a glycidylpropylether, or an arylglycidyl ether group. According to this embodiment of the invention, preferred glycidyl or glycidyloxy groups from which the group F is selected are selected from the group consisting of a glycidyl group, a propylene glycidylether and phenylene glycidyl ether group.

According to this embodiment of the invention, it is also preferred when F is selected from an organosilyl group-SiR¹₃ or a or a siloxy group —OSi(R¹)₃, wherein R¹ is a hydrocarbyl group as defined above for R¹ in formula (1) or (2). It is more preferred that R¹ in the organosilyl group SiR¹₃ or the siloxy group —OSi(R¹)₃ is independently selected from the group consisting of a C1-C8 alkyl group, a C2-C8 alkenyl group, a C6-C20 aryl group, a C7-C20 aralkyl or an alkylaryl group. It is most preferred that F is an organosilyl group selected from the group consisting of —SiMe₃, SiPh₃, —SiEt₃, —Si(iPr)₃, —SitBuMe₂, —SiMe₂Vinyl, or —SiMe₂Allyl, —OSiMe₃, —SiMe₂-O—SiMe₂-CH═CH₂, or a siloxy group selected from the group consisting of —OSiPh₃, —OSiEt₃, —OSi(iPr)₃, —OSitBuMe₂, —OSiMe₂Vinyl, or —OSiMe₂Allyl.

In another preferred embodiment according to the invention, silica particles are provided, wherein the one or more silanes of the formula (1) and/or (2) are exclusively selected from hydrophobic silanes.

According to the invention, a silane of the formula (1) or (2) is considered hydrophobic when the log P value of the partition coefficient P_{oct/wat}, which is defined as follows:

$$log {P}_{oct / wat} = log ( \frac{[ solute ] un - ionized octanol}{[ solute ] un - ionized water} )$$

of the compound H-L-F comprising the -L-F-group of the silane in a 50/50 mixture of water and octanol is equal or above about 0.5.
It is noted that according to the invention this definition applies in the case when the group A of a silane is of the formula

-L-F,

but also when the group A of a silane is of the formula

-{L-[SiR¹₂O]ₚ—SiR¹₂}ₘ-L-F.

In the latter case, the terminal structural group “-L-F” is taken into consideration as defined above.
In the case a silane of the formula (1) bears two different groups -L-F, it is considered hydrophobic when the log P value determined from the average of the partition coefficients of the two compounds H-L-F is equal or above about 0.5.
Experimentally, the partition coefficient is determined in a water/n-octanol mixture (water: 50 ml, octanol: 50 ml. To such mixture, 1 mL of the substance to be determined H-L-F is added at 25° C. The concentration of H-L-B in each of the layers is determined by a quantitative analytical spectrometric or spectroscopic method. Methods include, among others, for example nuclear magnetic resonance spectroscopy (NMR), gas chromatography mass spectrometry (GC/MS), high performance liquid chromatography mass spectrometry (HPLC/MS), infrared spectroscopy (IR), ultraviolet-visible spectroscopy (UV-VIS) and titration techniques etc.

Preferably, the log P value of the one or more silanes of the formula (1) and/or (2) is in the range from about 0.5 to about 10, more preferably in the range from about 1.0 to about 7, even more preferably in the range from about 1.5 to about 6, still more preferably in the range from about 2.0 to about 5.0, and most preferably in the range from about 2.5 to about 4.5.

According to this embodiment of the invention, it is also preferred that the hydrophobic silanes of the formula (1) and/or (2) are exclusively functionalized by one type of hydrophobic functional group selected from alkyl groups, halogenated alkyl groups, in particular perfluorinated alkyl groups, alkenyl groups, triorganosilyl-terminated alkyl groups, triorganosiloxy-terminated ester groups, and oxycarbonylalkyl groups, in particular linear C1-C12 alkyl groups and oxycarbonylalkyl groups, wherein the alkyl group of the oxycarbonylalkyl group is a C1 to C12 linear or branched alkyl group.

In a further preferred embodiment according to the invention, silica particles are provided, wherein the one or more silanes of the formula (1) and/or (2) are exclusively selected from hydrophilic silanes.

According to the invention, a silane of the formula (1) or (2) is considered hydrophilic when the log P value of the partition coefficient P_{oct/wat}, which is defined as above, of the compound H-L-F comprising the -L-F-group of the silane in a 50/50 mixture of water and octanol is below about 0.5.

In the case a silane of the formula (1) bears two different groups -L-F, it is considered hydrophobic when the log P value determined from the average of the partition coefficients of the two compounds H-L-F corresponding to the silan's -L-F groups is below about 0.5.

Preferably, according to the invention the log P value of the one or more silanes of the formula (1) and/or (2) is in the range from below about 0.5 to about −10, more preferably in the range from about 0.0 to about −5, even more preferably in the range from about −0.5 to about −3.0, still more preferably in the range from about in the range from −1.0 to about −2.5, and most preferably from about −1.0 to about −2.0.

According to this embodiment of the invention, it is also preferred that the hydrophilic silanes of the formula (1) and/or (2) are exclusively functionalized by one type of hydrophilic functional group selected from polyether groups, CH₃-end-capped polyether groups, SiMe₃-end-capped polyether groups or OH-terminated polyether groups, hydroxylated alkyl residues or polyhydroxylated alkyl residues present in the -L-F group.

In a preferred embodiment according to the invention, the silica particles are functionalized with two or more different silanes of the formula (1) and/or (2).

The silica particles according to this embodiment may be obtained by submitting silica particles to a reaction for functionalization with a mixture of two or more different silanes of the formula (1) and/or (2), or by performing two or more subsequent steps, wherein in each step the silica particles are submitted to a reaction for functionalization with one or more silanes of the formula (1) and/or (2). Accordingly, the silica particles according to this embodiment of the invention bear differently functionalized residues, which allows to provide silica particles with unprecedented and very specifically adjusted properties. Adjustment of the properties may be achieved not only by selection of a silane of the formula (1) or (2) comprising specific functional groups, but by combination of two or more specific silanes, and by regulating the ratio of different chains bearing said functional groups introduced by reaction of the silica particles with the different silanes of the formula (1) and/or (2). For instance, a silica particle may be rendered hydrophobic by functionalization using a silane of the formula (1) or (2) in which the groups F is a linear alkyl chain having more than 10 C-atoms or a perfluorinated alkyl chain having more than 10 C-atoms, and at the same time the silica particle may be rendered capable of being incorporated into the coating matrix by functionalization using a silane of the formula (1) or (2) in which the group F bears one or more coating-matrix-reactive group, for instance an acrylate group, a methacrylate group or an isocyanate group, which results in the incorporation of the silica particle into the coating matrix in the curing process. According to the invention, it is preferred when the difference of the log P values of at least two silanes of the formula (1) and/or (2) used for the functionalization of the silica particles is about 0.8 or higher, more preferred the difference of the log P values is about 1.5 or higher, even more preferred about 2.5 or higher, still further preferred about 3.5 or higher, and most preferably about 5.0 or higher.

Therein, it is preferred when the silane of the formula (1) or (2) having the higher log P value is a hydrophobic silane (i.e. log P≥about 0.5), while the silane having the lower log P value is a hydrophilic silane (i.e. log P<about 0.5).
It is noted that the difference of the log P values of different silanes as defined above is obtained by subtraction of the lower log P value from the higher log P value for the silanes in consideration.

In a further preferred embodiment according to the invention, each silica particle is functionalized by one or more hydrophobic silanes of the formula (1) and/or (2) and by one or more hydrophilic silanes of the formula (1) and/or (2).

Herein, the definition of “hydrophobic silane” and “hydrophilic silane” is the same as above. This definition is valid for all embodiments according to the invention.

In this embodiment, each silica particle is functionalized by one or more hydrophobic silanes of the formula (1) and/or (2), such as silanes in which the group F is an unsubstituted alkyl group having more than 6 C atoms, a perfluorinated alkyl group having more than 3 C atoms, or an alkyl group bearing only triorganosilyl groups as substituents having more than 6 C-atoms in the alkyl chain, and by one or more hydrophilic silanes, such as silanes in which the group F is an hydroxyl-terminated poly(alkoxy oxide), a hydroxylated or polyhydroxylated alkyl group, or an alkyl group substituted by one or more carboxylate groups. By proper selection of the groups F and the amounts of the respective silanes used for functionalization of the silica particles, the surface properties of the coatings comprising the silica particles can be adjusted in an exceptional manner. Likewise, different properties and requirements for the formulation of coating compositions, such as compatibility with the other components and rheological properties, may be addressed by proper selection of the hydrophobic and hydrophilic silanes used for the functionalization of the silica particles.

In another preferred embodiment according to the invention, the silica particles are functionalized with two or more different silanes of the formula (1) and/or (2), wherein in one or more of the silanes of the formula (1) and/or (2) the group F comprises one or more coating-matrix-reactive groups, and wherein the one or more further silanes of the formula (1) and/or (2) are either exclusively hydrophilic silanes or exclusively hydrophobic silanes.

According to this embodiment, the coating-matrix-reactive group or groups comprised by the group F of the silanes of the formula (1) and (2) are preferably selected from the group consisting of alkenyl, epoxy, acrylate, methacrylate, thiol, hydroxyl, alkoxy, carboxy (—COOH), amino and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.

By such selection of silanes for functionalization, silica particles which can be incorporated into the coating matrix of a cured coating composition via reaction of the one or more coating-matrix-reactive groups, and which at the same time display hydrophilic or hydrophobic properties caused by the presence of one or more hydrophilic groups or one or more hydrophobic groups as introduced by the functionalization with respective silanes of the formula (1) and/or (2) are provided.

Preferably, the one or more further hydrophilic silanes have groups F which exclusively contain hydrophilic functional groups selected from the group consisting of carboxylic acids, hydroxyl groups, groups, amino groups, polyether groups and thiol groups, and otherwise unfunctionalized alkyl groups bearing such moieties.

Likewise, preferably, the one or more further hydrophobic silanes have groups F which exclusively contain hydrophobic functional groups selected from the group consisting of ester groups, alkyl groups, alkenyl groups, halide groups and triorganosilyl groups, and otherwise unfunctionalized alkyl groups bearing such moieties.

In a still further preferred embodiment according to the invention, the silica particles are functionalized with two or more different silanes of the formula (1) and/or (2), wherein in one or more of the silanes of the formula (1) and/or (2) the group F comprises one or more coating-matrix-reactive groups, and the one or more further silanes of the formula (1) and/or (2) are exclusively hydrophilic silanes, wherein the group F of the one or more hydrophilic silanes comprises one or more hydrophilic groups selected from the group consisting of polyhydroxylated alkyl groups, polyether groups, hydrocarbon groups comprising quaternary ammonium groups, hydrocarbon groups comprising carboxylate groups, and hydrocarbon groups comprising one or more amino groups.

Preferred combinations of coating-matrix-reactive groups and hydrophilic groups present in the groups F of the hydrophilic silanes of the formula (1) and/or (2) used for the functionalization of the silica particles according to this embodiment are polyether groups, in particular OH-terminated polyether groups, alkyl-end-capped polyether groups, specifically methoxy, ethoxy, propoxy and butoxy-terminated polyether groups, and trialkylsiloxy-endcapped polyether groups, specifically —OSiMe₃, —OSiEt₃, —OSi(iPr)₃ groups combined with methacrylate or acrylate groups, polyether groups as specified above in this embodiment combined with isocyanate groups, and polyether groups as specified above in this embodiment combined with epoxy groups or alkenyl groups.

In yet another preferred embodiment according to the invention, the silica particles are functionalized with two or more different silanes of the formula (1) and/or (2), wherein in one or more of the silanes of the formula (1) and/or (2) the group F comprises one or more coating-matrix-reactive groups, and the one or more further silanes of the formula (1) and/or (2) are exclusively hydrophobic silanes, and wherein the group F of the one or more hydrophobic silanes comprises one or more hydrophilic groups selected from the group consisting of linear or branched unsubstituted alkyl groups, alkyl groups comprising difluoromethylene and/or trifluoromethyl groups, in particular perfluorinated alkyl groups, alkyl groups bearing triorganosilyl groups, organosiloxy groups, alkenyl groups or aromatic groups without substituents containing heteroatoms, in particular alkaryl groups and aralkyl groups.

Preferred combinations of coating-matrix-reactive groups and hydrophobic groups present in the groups F of the hydrophilic silanes of the formula (1) and/or (2) used for the functionalization of the silica particles according to this embodiment are isocyanate groups combined with unsubstituted alkyl groups, or fluorinated alkyl groups, acrylate or methacrylate groups combined with unsubstituted alkyl groups or fluorinated alkyl groups, or epoxy groups combined with unsubstituted alkyl groups or fluorinated alkyl groups.

In another preferred embodiment according to the invention, the silica particles comprise at least two kinds of different silica particles functionalized with silanes of the formula (1) and/or (2).

According to this embodiment, different types of silica particles are used as starting material for the functionalization of the silica particles with one or more silanes of the formula (1) and/or (2).

For example, it is according to this embodiment if the silica particles are provided by functionalizing particles of fumed silica having a D₅₀ average particle size of agglomerates in the range of about 50 to about 150 μm with one or more silanes of the formula (1) and/or (2), separately functionalizing particles of colloidal silica having a D₅₀ average particle size in the range of about 1 to about 150 nm with one or more silanes of the formula (1) and/or (2), and then mixing thus obtained functionalized silica particles.

Preferably, the two or more different kinds of silica particles are each functionalized by a different silane or a different mixture of silanes.

According to the invention it is preferred that a mixture of silica particles comprising two or more kinds of different types of silica particles obtained by separate functionalization with different silanes is provided
by mixing at least two different types of functionalized silica particles obtained by functionalization of one common type of silica particles used as precursors, which are separately functionalized with each a specific silane or a mixture of silanes of the formula (1) and/or (2) as defined in the previous embodiments which is different from at least one of the specific silane or silanes used for the functionalization of the other silica particle precursors; or alternatively
by mixing at least two different types of functionalized silica particles obtained from different types of silica particles used as precursors, which are separately functionalized with each a specific silane or a mixture of silanes of the formula (1) and/or (2) as defined in the previous embodiments which is different from at least one of the specific silane or silanes used for the functionalization of the other silica particle precursors.

According to this embodiment, it is generally preferred when the silica particles provided comprise two different kinds of silica particles, which may either be obtained by separate functionalization of a common type of silica particle precursor with two different types of silanes or two different mixtures of silanes, or by separate functionalization of two different types of silica particle precursors with two different types of silanes or two different mixtures of silanes, each followed by mixing the different kinds of silica particles in a specific ratio by weight.

According to the invention, it is further preferred that the at least two different kinds of silica particles functionalized with different silanes differ in the group F of the silanes of the formula (1) and/or (2) applied for functionalization of each kind of silica particles.

It is preferred when the silica particles comprise one or more types of particles functionalized by one or more types of silanes of the formula (1) and/or (2) in which the group F represents a polyether group, and one or more other types of particles functionalized by one or more types of silanes of the general formula (1) and/or (2) in which the group represents an alkyl group.
It is also preferred when one or more kinds of silica are functionalized with silanes of the formula (1) and/or (2) having a group F comprising a polyether group, while one or more further types of silica particles are functionalized with silanes of the formula (1) and/or (2) having a group F comprising one or more coating-matrix-reactive groups, or when one or more types of silica particles are functionalized with silanes of the formula (1) and/or (2) having a group F comprising one or more ester groups, alkyl groups or fluorine-containing moieties, while one or more further types of silica particles are functionalized with silanes of the formula (1) and/or (2) having a group F comprising one or more coating-matrix-reactive groups.
Functionalization of the group F of the silanes of the formula (1) and/or (2) by different types of functional groups results in different polarities of the silanes used for functionalization, and accordingly, in different polarities of thus obtained functionalized silica particles.

In a further preferred embodiment according to the invention, silica particles are provided which comprise at least two kinds of silica particles functionalized with different silanes having a different polarity.

The term “silanes having a different polarity” refers to silanes which have different log P values of the partition coefficient P of the groups H-L-F corresponding to the structural unit -L-F of the silanes, as defined above for the determination of hydrophilicity or hydrophobicity of the silanes.

According to the invention, it is preferred when the difference of the log P value of at least two silanes used for the functionalization of the at least two kinds of silica is about 0.8 or higher, more preferred the difference of the log P values is about 1.5 or higher, even more preferred about 2.5 or higher, still further preferred about 3.5 or higher, and most preferably about 5.0 or higher.

Therein, it is preferred when the silane of the formula (1) or (2) having the higher log P value is a hydrophobic silane (i.e. log P≥about 0.5), while the silane having the lower log P value is a hydrophilic silane (i.e. log P<about 0.5). Generally, the difference is obtained by subtracting the lower log P value from the higher log P value obtained for the silanes taken into consideration.

In a preferred embodiment according to the invention, silica particles are provided wherein the one or more silanes of the formula (1) and/or (2) are selected from the group consisting of:

R¹ₓR²₃₋ₓSi-L-[SiR¹₂O]ₚ—SiR¹₂-L-[—OC₂H₄]_{q}[—OC₃H₆]ᵣ[—OC₄H₈]ₛ—R⁴

R¹ₓR²₃₋ₓSi-L-[SiR¹₂O]ₚ—SiR¹₂-L-R⁵

HN{—SiR¹₂-L-[SiR¹₂O]ₚ—SiR¹₂-L-[—OC₂H₄]_{q}[—OC₃H₆]ᵣ[—OC₄H₈]ₛ—R⁴}₂

HN{—SiR¹₂-L-[SiR¹₂O]ₚ—SiR¹₂-L-R⁵}₂

R¹ₓR²₃₋ₓSi-L-[SiR¹₂O]ₚ—SiR¹₂-L-R⁵

wherein R¹, R², R⁴, L, p, q, r, s are each as defined above, and R⁵ is selected from the group consisting of alkyl, alkylcarbonyloxy, glycidyl, glycidyloxy, organosilyl, such as —SiMe₂-O—SiMe₂-CH═CH₂, —SiMe₃, —SiEt₃, —Si(iPr)₃, —SiPh₃, —Si(cyHex)₃, —SitBuMe₂, and —SitBuPh₂.

According to the invention, it is preferred when q+r+s is in the range of from about 2 to about 15, and it is particularly preferred when q is in the range of about 2 to about 15 while r and s=0, or r is in the range of about 2 to about 15 while q and s=0, or s is in the range of about 2 to about 15 while q and r=0.

According to the invention, it is also preferred when R⁴ is selected from the group consisting of hydroxyl, methoxy, ethoxy, n-propoxy, iso-propoxy, n-butoxy, iso-butoxy, tert-butoxy, methylcarbonxyloxy, tertbutylcarbonyloxy, —OSiMe₃, —SiMe₂-O—SiMe₂-CH═CH₂, glycidoxy groups or —SiMe₃, SiPh₃, —SiEt₃, —SitBuMe₃, —SiMe₂Vinyl, or —SiMe₂Allyl, and it is preferred if R⁵ is selected from the group consisting of methyl, ethyl, n-propyl, iso-propyl, n-butyl, tert-butyl, methylcarbonyloxy, ethylcarbonyloxy, tertbutylcarbonyloxy, glycidyl, glycidyloxy, —SiMe₂-O—SiMe₂-CH═CH₂, —SiMe₃, SiEt₃, —Si(iPr)₃ or, —SitBuMe₂, most preferably R⁵ is selected from methyl, glycidoxy, —SiMe₃ or or —SiMe₂-O—SiMe₂-CH═CH₂.

It is also preferred according to the invention when herein L is a divalent C2-C12-alkylene group, more preferably a divalent C2-C4 alkylene group, most preferably L is —(CH₂)₂— and/or —(CH₂)₃—, in each case optionally bonded to F via an oxygen atom.

In another preferred embodiment according to the invention, silica particles are provided wherein R² is alkoxy.

The group R² is defined as a hydrolysable group, and its presence in the silanes of the formula (2) is required to enable attachment of the group A via a silicon atom to the surface of the silica particles by condensation with one, two or three silanol OH-groups of the silica surface with the silyl group of the silane, thus forming siloxane units. Therein, one, two or three hydrolysable R² groups are cleaved. Accordingly, the ability of a silane for condensation with the silica surface and thus to be attached for functionalisation of the silica particle, in particular the rate of such reaction, depends on the kind of hydrolysable group R². Alkoxy groups are preferred hydrolysable groups R² according to the invention because the conditions under which these groups are hydrolysed in the presence of OH groups are well-known to the skilled person. Further, silyl groups bearing one, two or three alkoxy groups can be easily introduced into a target compound by a hydrosilylation reaction of either hydridoalkoxysilanes with any compound containing an unsaturated C—C bond, in particular alkenylpolyorganosiloxanes, alkenylcarbosilanes or alkenylcarbosiloxanes, wherein the alkenyl group is preferably a vinyl group, or by a hydrosilylation reaction of alkoxyalkenylsilanes, preferably alkoxyvinylsilanes, with hydridosilyl compounds, in particular with hydridopolyorganosiloxanes, hydridocarbosilanes or hydridocarbosiloxanes. As many hydridoalkoxysilanes and alkenylalkoxysilanes are commercially available, methods for production and handling of these compounds are well-known to the skilled person.

According to this embodiment, it is preferred that the silane of the formula (2) bears two or three alkoxy groups R₂, and more preferred the silane of the formula (2) bears three alkoxy groups as hydrolyzable groups R₂.

Therein, the alkoxy groups are independently selected from linear C1-C22 alkoxy groups such as methoxy, ethoxy, n-propoxy, n-butoxy, n-pentoxy, n-hexoxy, n-heptoxy or n-octyl groups, branched C1-C22 alkoxy groups such as iso-propoxy, iso-butoxy, tert-butoxy, iso-pentoxy, tert-pentoxy, neo-pentoxy and 2-ethylhexyoxy groups, and cyclic C3-C22 alkoxy groups such as cyclopropoxy, cyclobutoxy, cyclopentoxy, cyclohexoxy and cycloheptoxy groups, preferably the alkoxy group is selected from the group consisting of methoxy, ethoxy, n-propoxy, n-butoxy, n-pentoxy, n-hexoxy, iso-propoxy, iso-butoxy, tert-butoxy, neo-pentoxy, cyclopentoxy or cyclohexoxy groups, still more preferably the alkoxy group is selected from a methoxy, ethoxy or isopropoxy group, and most preferably the alkoxy group is selected from a methoxy group.

The present invention also relates to specific silanes, in particular to the silanes of the formula (1) as defined above for the functionalization of silica particles. In a preferred embodiment according to the invention, the silane compounds of the formula

HN[—SiR¹₂-A]₂ (1)

as defined above, wherein, when M is L, then the group F contains at least one heteroatom, such as N, O, P, S, Si, or a halogen atom, such as fluorine, chlorine, bromine or iodine, are provided.
These silanes are particularly useful in the production of functionalized silica particles.

Preferably, a compound of the formula (1) is provided wherein M is L, and the group F contains at least one heteroatom, such as N, O, P, 5, Si, or a halogen atom, such as fluorine, chlorine, bromine or iodine.

More preferably, in the compound of the formula (1) M is L, and the group F contains one or more oxygen atoms, more preferably F contains one or more oxygen atoms wherein at least one oxygen atom is an oxygen atom of an ether or an ester moiety, even more preferably the group F contains three or more oxygen atoms wherein at least three oxygen atoms are oxygen atoms of an oligo- or poly(alkylene oxide) group, still more preferably the group F contains five or more oxygen atoms wherein at least five oxygen atoms are oxygen atoms of an oligo- or poly(alkylene oxide) group, and even still more preferably the group F contains a poly(ethylene oxide) or a poly(propylene oxide) unit containing five or mare oxygen atoms.

Most preferably, in the compound of the formula (1) M is L, and F═—(O—CH₂CH₂)₄₋₁₂—OH, and specifically the compound is represented by the formula HN(—SiMe₂-(CH₂)₂₋₄—(O—CH₂CH₂)₄₋₁₂—H)₂,

more specifically the compound is represented by the formula
HN(—SiMe₂-(CH₂)₂—(O—CH₂CH₂)₄₋₁₂—OH)₂ or HN(—SiMe₂-(CH₂)₃—(O—CH₂CH₂)₄₋₁₂—OH)₂, and most specifically by the formula HN(—SiMe₂-(CH₂)₃—(O—CH₂CH₂)₁₀—OH)₂, or
F═—(O—CH₂CH₂)₄₋₁₂—OMe, and specifically the compound is represented by the formula
HN(—SiMe₂-(CH₂)₂₋₄—(O—CH₂CH₂)₄₋₁₂—OMe)₂ more specifically the compound is represented by the formula
HN(—SiMe₂-(CH₂)₂—(O—CH₂CH₂)₄₋₁₂—OMe)₂ or HN(—SiMe₂-(CH₂)₃—(O—CH₂CH₂)₄₋₁₂—OMe)₂, and most specifically by the formula HN(—SiMe₂-(CH₂)₃—(O—CH₂CH₂)_{7.5}—OMe)₂, or
F═—(O—CH₂CH₂)₄₋₁₂—OSiMe₃, and specifically the compound is represented by the formula
HN(—SiMe-(CH₂)₂₋₄—(O—CH₂CH₂)₄₋₁₂—OSiMe₃)₂ more specifically the compound is represented by the formula
HN(—SiMe₂-(CH₂)₂—(O—CH₂CH₂)₄₋₁₂—OSiMe₃)₂ or
HN(—SiMe₂-(CH₂)₃—(—CH₂CH₂)₄₋₁₂—OSiMe₃)₂, and most specifically by the formula
HN(—SiMe₂-(CH₂)₃—(O—CH₂CH₂)₁₀ OSiMe₃)₂.

According to the invention, it is also preferred that in the compound of the formula (1) according to this embodiment the group F contains an oxycarbonylalkyl group of the structure

F═—(OC(O)-alkyl,

wherein the alkyl group is a linear, branched or cyclic C1-C12 alkyl group, preferably a linear alkyl group selected from methyl, ethyl, propyl, butyl, pentyl, hexyl, heptyl, octyl, nonyl or decyl group, or a branched alkyl group selected from iso-propyl, sec-butyl, tert-butyl, neo-pentyl or from an alkyl group of the formula —CR^{a}R^{b}R^{c}, wherein the residues R^{a}, R^{b} and R^{c} are selected from linear alkyl groups and hydrogen and two or more of R^{a}, R^{b} and R^{c} are alkyl groups, more preferably the alkyl group is a linear alkyl group selected from ethyl or methyl, or from the formula —CR^{a}R^{b}R^{c}, wherein R^{c} is hydrogen or methyl, and R^{a} and R^{b} are linear alkyl groups having about 3 to about 11 carbon atoms in total. Most preferably, in the alkyl group of the formula —CR^{a}R^{b}R^{c} R^{c} is methyl, and R^{a} and R^{b} are linear alkyl groups having either 9 or 10 carbon atoms in total.

Further preferred compounds of the formula (1) according to this embodiment of the invention are for example the compounds represented by the formula

HN(—SiMe₂-(CH₂)₂₋₃—(O—C(O)alkyl))₂, specifically

HN(—SiMe₂-(CH₂)—(O—C(O)alkyl)₂ and HN(—SiMe₂-(CH₂)₃—(O—C(O)alkyl)₂, even more specifically H(—SiMe₂-(CH₂)₂—(O—C(O)—CMeR^{a}R^{b}))₂ and HN(—SiMe₂-(CH₂)₃—(O—C(O)—CMeR^{a}R^{b}))₂, wherein R^{a} and R^{b} are linear alkyl groups and have a total number of C-atoms from about 3 to about 9.

In an also preferred embodiment according to the invention, a compound of the formula (1) is provided wherein M is L, and the group F contains one or more silicon atoms, more preferably the group F contains one or more silicon atoms, wherein one of the silicon atoms is the silicon atom of a terminal triorganosilyl group or of a terminal triorganosiloxy group, such as —SiMe₂-CH═CH₂, —SiMe₃, —SiEt₃, —Si(iPr)₃, —SiPh₃, —Si(cyHex)₃, —SitBuMe₂, —SitBuPh₂, even more preferably the terminal triorganosilyl group of F is selected from —SiMe₂-CH═CH₂, —SiMe₃, or —SiEt₃ and bonded to an oxygen atom, or the terminal triorganosiloxy group is selected from —OSiMe₃, —OSiEt₃, and —OSi(iPr)₃ and bonded to a carbon atom, and still more preferably the terminal triorganosilyl group is selected from —SiEt₃ or —SiMe₃ and constitutes the end-capping group of a group selected from a poly(ethylene oxide) group, an poly(propylene oxide) group, or mixed poly(propylene oxide)-poly(ethylene oxide) group, or it constitutes the terminal group of a C1-C12 linear alkyl group or a C1-C12 alkenyl group. Most preferably, in the compound of the formula (1) M is L, and

F═—(O—CH₂CH₂)₄₋₁₂—OSiMe₃, or

F═—(O—CH₂CH₂CH₂)₄₋₁₂—OSiMe₃, or

F═—(O—CH₂CH₂)₄₋₁₂—OSiEt₃, or

F═—(O—CH₂CH₂CH₂)₄₋₁₂—OSiEt₃.

Particularly preferred compounds of the formula (1) according to this embodiment are the compounds of the formulas

HN(—SiMe₂-(CH₂)₂₋₃—(O—CH₂CH₂CH₂)₄₋₁₂—OSiMe₃)₂, specifically
HN(—SiMe₂-(CH₂)₂—(O—CH₂CH₂CH₂)₁₀—OSiMe₃)₂ and HN(—SiMe₂-(CH₂)₃—(O—CH₂CH₂CH₂)₁₀—OSiMe₃)₂, or
HN(—SiMe-(CH₂)₂₋₃—(O—CH₂CH₂)₄₋₁₂—OSiEt₃)₂, specifically
HN(—SiMe₂-(CH₂)₂—(O—CH₂CH₂)_{7.5}—OSiEt₃)₂ and HN(—SiMe₂-(H₂)₃—(O—CH₂CH₂)_{7.5}—OSiEt₃)₂, or
HN(—SiMe₂-(CH₂)₂₋₃—(O—CH₂CH₂CH₂)₄₋₁₂—OSiEt₃)₂, specifically
HN(—SiMe₂-(CH₂)₂—(O—CH₂CH₂CH₂)₁₀—OSiEt₃)₂ and HN(—SiMe₂-(CH₂)₃—(O—CH₂CH₂CH₂)₁₀—OSiEt₃)₂.

In another preferred embodiment according to the invention, a silane of the general formula (1) as defined above is provided, wherein the optional substituents of the hydrocarbyl radicals F are selected from the group consisting of alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy, 1,3-dicarboxy, diesters, 1,3-diesters, nitro (—NO₂), cyano (—CN), alkyl sulfonyl fluoride groups, as well as donor and acceptor groups in the Michael addition reaction.

The present invention also relates to a process for the production of functionalized silica particles, in particular a process for the production of the functionalized silica particles as described above.

According to the invention, the present invention provides a process for the production of functionalized silica particles, comprising
contacting silica particles with one or more silanes of the formula (1) and/or (2):

HN[—SiR¹₂-A]₂ (1),

and/or

R¹ₓR²₃₋ₓSi-A (2)
as defined above.

According to this embodiment, a D₅₀ average particle size of the silica particles applied may be up to about 1000 μm as determined by dynamic light scattering (DLS) or TEM (transmission electron microscopy). However, it is preferred that the silica particles have a D₅₀ average particle size of below about 800 μm, and even more preferred below about 500 μm, and it is preferred that the silica particles are either fumed silica particles or colloidal silica particles, in particular colloidal silica particles in a suspension.

According to this embodiment, the one or more silanes of the formula (1) and/or (2) applied for the functionalization of the silica particles are as defined in the above embodiments directed at the silica particles functionalized with one or more silanes of the formula (1) and/or (2).

According to the invention, the method of contacting silica particles with one or more silanes of the formula (1) and/or (2) as defined above is not limited to any particular method and such methods would be known to one of ordinary skill in the art.

It is preferred that the silica particles and the one or more silanes used for functionalization are contacted in an open or closed reaction vessel; further, it is preferred that when a mixing device is used, a homogeneous reaction mixture is formed; and it is also preferred that the reaction vessel may be cooled or heated, depending on the silane or silanes applied. Such a mixing device may be a mixer or stirrer, wherein all known types of industrial reactors, blenders and mixers may be applied, such as a ribbon mixer, a twin shaft mixer, a vertical mixer, a mixing reactor, or a drum blender; it is also possible to contact the starting materials by using a kneader, a ball mill or a screw-type extruder. Depending on the silane or silanes applied, it is preferred to contact the starting materials at elevated temperatures of at least about 40° C.

The reaction effected by contacting the silica particles and the one or more silanes of the formula (1) and/or (2) may be performed in the presence of one or more solvents, and it may be performed under reduced or elevated pressure, wherein an inert atmosphere may be applied when contacting the afore-mentioned reaction partners.

The contacting may be performed in a batch-wise process or in a continuous process.

The time of contacting the silica particles and one or more silanes of the formula (1) and/or (2) is not limited in a particular way, however, preferably conditions are chosen to obtain the desired degree of functionalization of the silica particles' surface within a reaction time of less than about 6 h, more preferably within less than about 4 h, and even more preferably within less than about 2 h in case a batch-wise process is applied.

In a preferred embodiment according to the invention, a process for the production of functionalized silica particles is provided, wherein contacting the silica particles and the one or more silanes of the formula (1) and/or (2) is in the presence of a solvent.

In general, the process for the production of functionalized silica particles may be conducted in the presence or in the absence of one or more solvents, wherein it is preferred that the process is conducted in the presence of one or more solvents, even more preferably in the presence of one solvent which is not a mixture of compounds but a single compound. According to the present invention, the term “solvent” refers to any compound or mixtures thereof which is in liquid state under reaction conditions, and which is suitable as a medium for conducting the functionalization of silica particles by contacting them with one or more compounds of the formula (1) and/or (2) therein. Preferably, the solvent is an organic compound or a mixture of organic compounds.

Accordingly, the solvent is preferably inert to the silica particles used as starting material and the silane compounds of the formula (1) and/or (2) according to present invention under reaction conditions. Furthermore, the starting materials of the formula (1) and (2) are preferably soluble in the solvent or fully miscible with the solvent, respectively. Preferably, the solvent is selected from the group of organic solvents consisting of aliphatic hydrocarbons, cycloaliphatic hydrocarbons, aromatic hydrocarbons, diorganocarbonates, ethers, ketones, alcohols, esters and combinations thereof.

According to the invention, preferred aliphatic hydrocarbons are selected from linear and branched C5-C24 alkyls, for example pentane, hexane, heptane, octane and mixtures thereof as for example high boiling or low boiling petrol ether;

preferred cycloaliphatic hydrocarbons are selected from C5-C24 cycloalkanes, for instance, cyclopentane, cyclohexane or cycloheptane;
preferred aromatic hydrocarbons are alkyl-substituted aryl compounds based on benzene, such as toluene, xylene, mesitylene, tert-butyl benzene and ethylbenzene;
preferred diorganocarbonates are dimethyl carbonate, diethyl carbonate, ethylene carbonate and propylene carbonate;
preferred ethers are tert-amyl ethyl ether, cyclopentyl ethyl methyl ether, di-tert-butyl ether, di(propylene glycol) methyl ether, dibutyl ether, diisopropylether, dimethoxyethane, 1,4-dioxane, 2-(2-methoxyethoxy)ethanol, methyl tert-butyl ether, 2-methyltetrahydrofuran, morpholine, polyethylene glycol, propylene glycol methyl ether, tetrahydrofuran, tetrahydrofurfuryl alcohol, tetrahydropyran, and 2,2,5,5-tetramethyltetrahydrofuran; preferred ketones are acetone, methylethyl ketone, methyl isobutyl ketone, diisobutylketone, or methyl amyl ketone;
preferred alcohols are secondary or tertiary alcohols, such as 1-methoxy-2-propanol or tert-butyl alcohol; preferred esters are acetates of linear or branched C2-C24 alcohols, such as ethyl acetate, propyl acetate, iso-propyl acetate, butyl acetate, sec-butyl acetate, tert-butyl acetate, iso-amyl acetate, hexyl acetate or triacetine.

Therein, it is further preferred that the solvent applied has a high boiling point, which according to the invention is a boiling point above about 100° C. under standard pressure, which is for example the case for toluene, ortho-, meta- and para-xylene, dioxane and 1-methoxy-2-propanol.

According to this embodiment, it is preferred when the solvent or solvents are selected from the group consisting of toluene, xylene, dioxane and 1-methoxy-2-propanol.
A solvent may be included to improve the functionalization reaction regarding homogeneity of the reaction mixture and heat transport during the reaction.

In a further preferred embodiment according to the invention, the process for the production of silica particles is conducted at a temperature above about 40° C., more preferably at a temperature above about 50° C., most preferably at a temperature in the range of about 55° C. to about 120° C.

By applying an elevated temperature, the reaction rate of the condensation reaction taking place in the functionalization of the silica particle can be increased. However, in order to prevent undesired side reactions, the temperature is preferably kept below about 250° C., more preferably below about 180° C., even more preferably below about 150° C., and most preferably at equal or below about 120° C.

In another preferred embodiment according to the invention, the silica particles used as starting material in the process for the production of functionalized silica particles are selected from colloidal silica particles having an average particle size in the range from about 1 to about 300 nm, preferably about 1 to about 150 nm as determined by dynamic light scattering (DLS), or from fumed silica having an average particle size in the range from about 1 to about 600 μm, preferably about 20 to about 400 μm as determined by DLS or transmission electron microscopy (TEM).

As described above, the silica particles can be selected from silica particles which are present in colloidal form, i.e. as primary particles, typically in a dispersion, or from silica particles which are agglomerates of primary particles, which for example typically applies to fumed silica particles. While all types of silica particles can be submitted to the process for the production of functionalized silica particles according to the invention in order to obtain the functionalized silica particles functionalized by one or more silanes of the formula (1) and/or (2) according to the invention, it is preferred that the silica particles have a D₅₀ average particle size particle size as determined by dynamic light scattering in the range from about 1 nm to about 800 μm, wherein it is more preferred when the D₅₀ average particle size of colloidal silica primary particles is in the range of about 1 to about 300 nm, even more preferred about 2 to about 150 nm, and most preferred about 5 to about 50 nm, or wherein it is more preferred when the D₅₀ average particle size of silica agglomerate particles is in the range from about 1 to about 800 μm, even more preferred about 10 to about 300 μm, and most preferred about 50 to about 150 μm. The particle size may alternatively be determined by TEM; however, DLS is the preferred means for measuring the D₅₀ particle size value.

In still another preferred embodiment of the process for the production of functionalized silica particles according to the invention, contacting the silica particles and the one or more silanes of the formula (1) and/or (2) is in the presence of a condensation catalyst selected from the group consisting of consisting of organotin, organozinc, organotitanium and organoboron compounds, primary amines, secondary amines, tertiary amines, ammonium compounds, cyclic amines, aliphatic amines, metal oxides, metal hydroxides, metal carbonates, ammonia and combinations thereof, preferably of organotin and organotitanium compounds.

A condensation catalyst may be used to increase the rate of the condensation reaction, in particular to achieve an appropriate reaction rate at a moderate reaction temperature.

In a preferred embodiment according to the invention, in the silanes of the formula (1) the group M is L.

According to this embodiment, the silanes of the formula (1) do not contain an oligo- or polysiloxy moiety.

In another preferred embodiment of the process for the production of functionalized silica particles according to the invention, in the silanes of the formula (1) and/or (2) F is selected from the group consisting of:
alkyl,
alkenyl,
alkylcarbonyloxy,
polyalkylene oxide groups, preferably of the general formula:

[—OC₂H₄]_{q}[—OC₃H₆]ᵣ[OC₄H₈]ₛR⁴

wherein
[—OC₂H₄] represents an ethyleneoxy unit,
[—OC₃H₆] represents a propyleneoxy unit, and
[—OC₄H₈] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R⁴ is selected from the groups consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR¹₃, wherein R¹ is independently selected from the groups as defined above for formula (1) and (2), and siloxy groups such as —OSi(R¹)₃, wherein R¹ is independently selected from the groups as defined above for formula (1) and (2).

In a further preferred embodiment of the process for the production of functionalized silica particles according to the invention, the group F of the one or more silanes of the formula (1) and/or (2) comprises at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy, 1,3-dicarboxy, diesters, 1,3-diesters, nitro (—NO₂), cyano (—CN), alkyl sulfonyl fluoride groups, as well as donor and acceptor groups in the Michael addition reaction.

In general, all silanes of the formula (1) or (2) which are described above as being preferred for the provision of functionalized silica particles are likewise preferred in the process for the production of functionalized silica particles according to the invention.

In a still further preferred embodiment according to the invention, in the process for the production of functionalized silica particles the one or more silanes of the formula (1) and/or (2) are exclusively selected from hydrophobic silanes, or the one or more silanes of the formula (1) and/or (2) are exclusively selected from hydrophilic silanes.

According to this embodiment, the same definition of “hydrophobic silanes” and “hydrophilic silanes” as provided above based on the log P value of the partition coefficient P_{oct/wat}, which is defined as follows:

$$log {P}_{oct / wat} = log ( \frac{[ solute ] un - ionized octanol}{[ solute ] un - ionized water} )$$

of the compound H-L-F comprising the -L-F-group of the silane in a 50/50 mixture of water and octanol applies.

For the hydrophobic silane or silanes it is preferred when the log P value is in the range from about 0.5 to about 10, more preferably in the range from about 1.0 to about 7, even more preferably in the range from about 1.5 to about 6, still more preferably in the range from 2.0 to about 5.0, and most preferably in the range from about 2.5 to about 4.5.

For the hydrophilic silane or silanes, it is preferred when the log P value is in the range from about 0.5 to about −10, more preferably in the range from about 0.0 to about −5, even more preferably in the range from about −0.5 to about −3.0, still more preferably in the range from about in the range from −1.0 to about −2.5, and most preferably from about −1.0 to about −2.0.

According to this embodiment of the invention, it is preferred that the hydrophobic silanes of the formula (1) and/or (2) are exclusively functionalized by one type of hydrophobic functional group selected from alkyl groups, halogenated alkyl groups, in particular perfluorinated alkyl groups, alkenyl groups, triorganosilyl-terminated alkyl groups, ester groups, and oxycarbonylalkyl groups, in particular linear C1-C12 alkyl groups and oxycarbonylalkyl groups, wherein the alkyl group of the oxycarbonylalkyl group is a C1 to C12 linear or branched alkyl group.

According to this embodiment of the invention, it is also preferred that the hydrophilic silanes of the formula (1) and/or (2) are exclusively functionalized by one type of hydrophilic functional group selected from polyether groups, CH₃-end-capped polyether groups, SiMe₃-end-capped polyether groups or OH-terminated polyether groups, hydroxylated alkyl residues or polyhydroxylated alkyl residues present in the -L-F group.

In another preferred embodiment of the process for the production of functionalized silica particles, according to the embodiment, the silica particles are contacted with one or more silanes of the formula (2), wherein R² is an alkoxy group.

According to this embodiment, it is preferred that the silane of the formula (2) bears two or three alkoxy groups R², and more preferred the silane of the formula (2) bears three alkoxy groups as hydrolyzable groups R².

Therein, it is preferred when the alkoxy groups are independently selected from linear C1-C22 alkoxy groups such as methoxy, ethoxy, n-propoxy, n-butoxy, n-pentoxy, n-hexoxy, n-hexoxy, n-heptoxy or n-octoxy groups, branched C1-C22 alkoxy groups such as iso-propoxy, iso-butoxy, tert-butoxy, iso-pentoxy, tert-pentoxy, neo-pentoxy and 2-ethylhexyoxy groups, and cyclic C3-C22 alkoxy groups such as cyclopropoxy, cyclobutoxy, cyclopentoxy, cyclohexoxy and cycloheptoxy groups, more preferably the alkoxy group is selected from the group consisting of methoxy, ethoxy, n-propoxy, n-butoxy, n-pentoxy, n-hexoxy, iso-propoxy, iso-butoxy, tert-butoxy, neo-pentoxy, cyclopentoxy or cyclohexoxy groups, still more preferably the alkoxy group is selected from a methoxy, ethoxy or isopropoxy group, and most preferably the alkoxy group is selected from a methoxy group.

In a preferred embodiment of the process for the production of functionalized silica particles according to the invention, two or more silanes of the formula (1) and/or (2) as defined above are contacted with the silica particles in one step, or wherein two or more silanes of the formula (1) and/or (2) are contacted with silica particles in two or more steps.

By the process according to this embodiment, silica particles bearing differently functionalized residues are obtained, which allows to provide silica particles with unprecedented and very specifically adjusted properties, as already explained above. According to this embodiment, it is preferred that the silica particles are contacted with at least one or more silanes which are either hydrophobic or hydrophilic, which provides the silica particles with the corresponding surface properties, and with at least one type of silane bearing a coating-matrix-reactive functional group, which enables incorporation of the silica particles into the coating matrix.

In a further preferred embodiment of the process for the production of functionalized silica particles according to the invention, the silica particles are contacted with one or more silanes of the formula (1) and/or (2) comprising one or more coating-matrix reactive moieties, and with one or more hydrophobic silanes of the formula (1) and/or (2) in the absence of hydrophilic silanes of the formula (1) and/or (2), or

wherein the silica particles are contacted with one or more silanes of the formula (1) and/or (2) comprising one or more coating-matrix reactive moieties, and with one or more hydrophilic silanes of the formula (1) and/or (2) in the absence of hydrophobic silanes of the formula (1) and/or (2).

By such preferred selection of the two or more silanes contacted with the silica particles, superior surface properties of the silica particles can be provided.

In a still further preferred embodiment of the process for the production of functionalized silica particles according to the invention, the silica particles are contacted with one or more silanes of the formula (1) in the presence of at least about 0.5 equivalent of water based on the molar amount of the silane or silanes of the formula (1), preferably in the presence of at least about 1.0 equivalent of water, most preferably in the presence of at least about 1.5 equivalents of water based on the molar amount of the silane or silanes of the formula (1).

Depending on the functionalization of the silanes and/or the hydrolyzable groups present in the silane or silanes, the presence of water promotes the condensation reaction of the silanes with the silica particles to be functionalized.

In another aspect, the present invention relates to functionalized silica particles comprising one or more monovalent groups A,

wherein A is a group of the formula -M-F,
wherein M is selected from L or a group of the formula:

-{L-[SiR¹₂O]ₚ—SiR¹₂}ₘ-L-, wherein

L is independently selected from the group consisting of divalent alkylene groups having at least two carbon atoms, which can be interrupted by one or more —O—, —NR³—C(O)—, and/or —NR³—, —OC(O)NR³—, —NR³—C(O)—NR³— moieties, and can be substituted by one or more OH groups, wherein R³ is hydrogen, Me₃Si— or C1-C8-alkyl, preferably L is a divalent C2-C12-alkylene group, more preferably a divalent C2-C4 alkylene group, most preferably L is —(CH₂)₂— and/or —(CH₂)₃—,
R¹ is independently selected from non-hydrolyzable residues, preferably hydrocarbyl groups, more preferably alkyl groups, most preferably R¹ is methyl,
p=1 to about 9, preferably p=1 or 4, more preferably p=4,
m=1 to about 20, preferably m=1, and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups

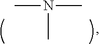

or quaternary ammonium groups

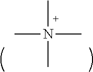

and may be substituted by OH groups, SH groups, halide groups, organosilyl groups or triorganosiloxy groups,
and the group A is bonded to the silica particle via a silicon atom which is linked to the silicon dioxide network of the silica particle via one or more oxygen atoms, wherein the valences of said silicon atom which are not occupied by the group -A or an oxygen atom are occupied by a substituent R¹ as defined above.

As is clear to the skilled person, such silica particles correspond to the silica particles as described in the embodiments above, without being limited to the functionalization by the silanes of the general formula (1) and/or (2). Accordingly, the specific selections and preferred embodiments as described above for the group A and its constituents -M-, —F, R¹, and the parameters m and p present in the formula -{L-[SiR¹₂O]ₚ—SiR¹₂}ₘ-L-, which may represent M, as described in the embodiments above are also applicable and preferred for the functionalized silica particles comprising one or more monovalent groups A according to the invention.

It is explicitly noted that, as defined above for the silanes of the formula (1) and (2) in an analogous manner, the term “hydrophobic group A” refers to a group A for which the log P value of the partition coefficient P_{oct/wat} of the compound H-L-F comprising the terminal L-F-groups of the group A in a 50/50 mixture of water and octanol is equal or above 0.5, while the term “hydrophilic group A” refers to a group A for which the log P value of the partition coefficient of the compound H-L-F comprising the L-F-groups of the group A in a 50/50 mixture of water and octanol is below 0.5.

The present invention further relates to the use of the silica particles according to any of the previous embodiments or obtained by the processes described therein for the manufacture of coating compositions.

Therein, the term “coating compositions” is not particularly limited and refers to any composition used as a covering that is applied to the surface of an object, usually referred to as the substrate. The purpose of applying the coating composition may be decorative, functional, or both. The coating resulting from application of the coating composition itself may be an all-over coating, completely covering the substrate, or it may only cover parts of the substrate. Paints and lacquers are coatings that mostly have dual uses of protecting the substrate and being decorative, but may be used only for decoration, or only for the function of protection, for example by preventing corrosion.

Functional coating compositions may be applied to change the surface properties of the substrate, such as adhesion, wettability, corrosion resistance, susceptibility to fouling, scratch resistance, gloss, wear resistance. In other cases, e.g. semiconductor device fabrication (where the substrate is a wafer), the coating resulting from application of a coating composition adds a completely new property, such as a magnetic response or electrical conductivity, and forms an essential part of the finished product.

According to the invention, the coating composition is preferably a protective coating composition, i.e. its application results in a coating or paint that is at least to some extent protecting the substrate, which selected from the group consisting of coating compositions for sealing and waterproofing wood, coating compositions for sealing the surface of concrete, film-forming sealers and floor paint, seamless polymer or resin flooring, bund wall or containment lining, coating compositions for waterproofing and damp proofing of concrete walls, roof coating compositions, coating compositions for sealing and waterproofing of masonry, coating compositions for preserving machinery, equipment and structures, maintenance coating compositions and paints for metals, alloys and concrete, chemical resistant coating compositions, coating compositions for the improvement of wear resistance, in particular anti-friction, wear and scuffing resistance coating compositions for rolling-element bearings, hard anti-scratch coating compositions on plastics and other materials to reduce scratching and abrasion loss, barrier coating compositions on concrete, metals and alloys subject to erosion/abrasive attack, anti-corrosion coating compositions, in particular underbody sealant for cars, anticorrosion coating compositions for preserving equipment and structural steel from degradation, coating compositions for thermal insulation and protective fireproofing of structural steel, coatings for passive fire protection, coating compositions for insulation, coating compositions to waterproof paper and waterproof fabric, anti-graffiti coating compositions, anti-fog coating compositions, anti-ice coating compositions, anti-dirt coating compositions, easy-to-clean coating compositions, antimicrobial coating compositions for obtaining antimicrobial surfaces, and coating compositions to improve the foul release and anti-fouling properties of a surface, for instance of a hull.

The coating compositions resulting in the formation of the coatings are not particularly limited regarding to their formulation, as long as they contain the functionalized silica particles according to the present invention.

In a preferred embodiment according to the invention, the coating compositions manufactured using the functionalized silica particles according to the invention are curable coating compositions.

The curable coating composition according to the present invention can be any coating composition capable of being cured, which refers to the toughening or hardening of a polymer material by a cross-linking of polymer chains by a chemical process. The curing process as mentioned before can be effected by heat, radiation, electron beams, or chemical additives, which also includes contact with moisture or oxygen from the ambient air, and characteristically entails an increase in viscosity or hardness. The term is also used in case monomers present in a composition bear more than one site for polymerization and polymerization and cross-linking of the monomers occur at the same time. This is for example the case in polyacrylate monomers, which comprise several acrylate moieties serving as sites for polymerization and cross-linking.

Further, the term “curable coating compositions” according to the invention refers to diverse types of compositions containing various organic polymers, mixtures of organic polymers and organic monomers, or organic monomers.

Preferred curable coating composition types in which the silica particles according to the invention are used are
epoxy/amine compositions
Michael addition curing compositions
radical polymerization curing compositions
condensation curing compositions, and
addition curing compositions.

According to the invention, the term “epoxy/amine composition” refers to an epoxy coating composition wherein an anime-based hardener is used in the curing process, which is selected from aliphatic amines, polyamides and amidoamines, cycloaliphatic amines, aromatic amines, mercaptanes, anhydrides, aromatic anhydrides, alicyclic anhydrides, aliphatic anhydrides. In many cases, an additional curing catalyst is present in such composition, mostly selected from Lewis base catalysts, such as tertiary amines or Lewis acid catalysts such boron based catalysts, quarternary ammonium salts such as tetramethylammonium hydroxide, phosphines such as triphenyl phosphine, from organozinc, organotin, organoboron, organotitanium compounds, compounds of group V elements such as WCl₆, metal oxides, and amines. Such compositions are often able to react at ambient temperatures and are thus often chosen for any application that is sensitive to high temperatures.

Amine cured epoxy coatings are prepared by combining an epoxy resin with an appropriate amine hardener. Primary or secondary amine groups attack a carbon atom of the three membered epoxide ring, leading to an opened ring with an amine group and hydroxyl group. Primary amines form secondary amines, which can react again to form tertiary amines, although at slower rates. The hardener unit may have two or more anime functional groups, enabling the hardener to cross-link across multiple epoxy resin molecules, increasing crosslink density and various resistances of the resultant epoxy. Aliphatic amines react more readily than cycloaliphatic amines and much more so than aromatic amines, but the latter, less reactive amines tend to form epoxies of much higher temperature resistivity. Aromatic amines are no longer often used due to negative health effects of handling those corresponding compounds.
Each class of amine hardeners has its own advantages and disadvantages in terms of curing speed, chemical resistance, solvent resistance, temperature compatibility, flexibility, viscosity, mechanical strength, cross-link density, color and toxicity. In addition, each class contains a whole family of various hardeners that further vary these properties.

According to the invention, the term “Michael addition curing compositions” refers to coating compositions whose curing involves the Michael addition reaction, i.e. the addition of various nucleophiles to (conjugated) unsaturated compounds with electron-withdrawing substituents. It allows for the synthesis of a wide range of highly complex macromolecules under relative mild conditions and in a very efficient manner with often quantitative yield. Basically, any monomer with an activated double bond such as, α,β-unsaturated aldehydes or ketones, vinyl esters, vinyl sulfones, imidazoles, and maleimides undergo a Michael addition with a nucleophile such as thiol, amine or any stabilized carbanion. Michael addition reactions can also be employed to prepare polymers of various architectures. The monomers of this type of step-growth polymerization are typically molecules that contain conjugated bisdienes and bisdienophiles (A-A-type and B-B-type monomers or co-monomers; at this point, the term “A” refers to a reactive group present in an “A-A-type monomer”, e.g. a conjugated bisdiene, which is reacted with a “B-B-type monomer”, e.g. a bisdienophile, in order to obtain an “(A-A-B-B)ₙ-polymer”, not the group “A” present in the silanes of the formula (1) and (2)).

The term “radical polymerization curing compositions” according to the invention refers to compositions that are cured by free radical polymerization. Free radical polymerization consists of three fundamental steps, initiation, propagation, and termination. Initiation involves the formation of radicals followed by the radical's reaction with a vinyl monomer, propagation is the rapid and progressive addition of monomers to the growing polymer chain without a change of the active center, and termination is the destruction of the growth active center, usually by combination or coupling of the radicals of two growing polymer chains or by disproportionation. In addition to these three processes, chain transfer might occur, which is the transfer of the growth active site from the active chain to an inactive (dormant) one, a monomer or a solvent molecule (transfer agent).

According to the invention, the term “condensation curing compositions” refers to compositions which are cured by condensation polymerization, which is a form of step-growth polymerization. Small molecules react with each other to form larger structural units while releasing smaller molecules as a byproduct, such as water or methanol. A well-known example of a condensation reaction is the esterification of carboxylic acids with alcohols. If both moieties are difunctional, the condensation product is a linear polymer, and if at least one of the moieties is tri- or tetra-functional, the resulting polymer is a crosslinked polymer (i.e. a three-dimensional network). Adding monomers with only one reactive group will terminate a growing chain, and consequently lower the (average) molecular weight. Thus, the average molecular weight and the crosslink density will depend on the functionality of each monomer involved in the condensation polymerization and on its concentration in the mixture.

Finally, according to the invention the term “addition curing compositions” refers to polyurethane-based compositions which are formed from the of an organic diisocyanate or polyisocyanate with a diol or polyol compound, which leads to urethane linkages in the backbone (—NH—C(═O)—O—).

In a further preferred embodiment according to the invention, the curable coating compositions according to the invention comprise organic polymers, mixtures of organic polymers and organic monomers, or organic monomers selected from polycarbonates, poly(meth)acrylates, polyolefins, polyurethanes, polyethers, polyesters, polyorganosiloxanes, various types of epoxy resins, such as glycidyl-based epoxy resins, novolac-based epoxy-resins or aliphatic epoxy resins, as well as various copolymers and mixtures of polymer compounds, and the corresponding monomers, i.e. mono(meth)acrylates, dimethyl carbonate and diols, in particular diphenylmethane derivatives, olefins, and polyisocyanates, or mixtures thereof.

It is also preferred that the coating compositions according to the invention, in particular the curable coating compositions according to the invention optionally comprise further additives, such as further photoinitiators, light stabilizers, fillers, in particular carbon black, metal oxide particles and silica particles not according to the invention, functionalized silica compounds other than according to the invention, flame retardants, solvents, curing catalysts, reactive surface agents, colorants, stabilizers, preservatives, light stabilizers, surfactants, leveling agents and other rheological agents.

According to the invention, the silica particles according to the invention as defined in the above embodiments are used in the manufacture of coating compositions, preferably curable coating compositions, by mixing the silica particles according to the invention with the other components of the coating composition, either by adding the silica particles to the finished preparation and mixing, by adding the other components to the silica particles and mixing, or by adding the silica particles at any point during the manufacture of the coating composition and mixing. Any means for mixing may be applied which is suitable depending on the type of coating composition which is manufactured and the apparatus used for the manufacture.

In a preferred embodiment according to the invention, the silica particles according to the invention are used as marine anti-fouling additives, general anti-fouling additives, anti-ice additives, anti-dirt additives, anti-fog additives, self-cleaning additives, anti-adhesion, anti-dust, anti-fingerprint, and anti-graffiti additives, in particular as general anti-fouling additives or anti-fog additives in coating compositions.

Preferably, the silica particles according to the invention are used as general anti-fouling additives, in particular as marine anti-fouling additives. It has been demonstrated that coating compositions manufactured using the silica particles according to the invention as defined in the above embodiments provide excellent anti-fouling properties to surfaces, in particular to such surfaces exposed to a marine environment. This makes the use of the silica particles according to the invention highly desirable in the manufacture of curable coatings for marine vessels, hulls, ships, sea concrete structures, undersea concrete structures, wooden sea structures, undersea wooden structures, plastic sea structures and undersea plastic structures and all kinds of buildings, masonry, constructions and equipment exposed to a marine environment.

Also, preferably, silica particles according to the invention are used as anti-fog additives, more preferably as anti-fog additives for the manufacture of coating compositions for the coating of plastic substrates, in particular of polycarbonate substrates or PMMA (polymethylmethacrylate) substrates. It has been demonstrated that coating compositions manufactured using the silica particles according to the invention as defined in the above embodiments provide excellent anti-fog properties to surfaces, in particular when the coating composition is applied to surfaces of polycarbonate or methacrylate or acrylate substrates, in particular PMMA substrates. This makes the use of the silica particles according to the invention in the manufacture of curable coatings for optical devices, screens and shields or exterior lamps, in particular automotive headlamps, highly desirable.

The present invention also relates to coating compositions comprising the silica particles according to the invention as described in the above embodiments.

As stated above, the coating compositions according to the invention are characterized in that it comprises the silica particles according to the invention. The coating compositions may be decorative, functional or both, and may be applied as all-over coatings completely covering the substrate, or it may only cover parts of the substrate. Paints and lacquers are coatings that mostly have dual uses of protecting the substrate and being decorative, but may be used only for decoration, or only for the function of protection, for example by preventing corrosion. Accordingly, paints and lacquers comprising the silica particles according to the invention are comprised by this embodiment of the invention. Functional coating compositions according to the invention may be applied to change the surface properties of the substrate, such as adhesion, wettability, corrosion resistance, susceptibility to fouling, scratch resistance, gloss, and wear resistance. In other cases, e.g. semiconductor device fabrication (where the substrate is a wafer), the coating resulting from application of a coating composition adds a completely new property, such as a magnetic response or electrical conductivity, and forms an essential part of the finished product.

According to the invention, the coating composition is preferably a protective coating composition as defined above, most preferably a curable protective composition. The coating compositions resulting in the formation of the coatings are not particularly limited regarding to their formulation, as long as they contain functionalized silica particles according to the present invention.

According to the invention, it is preferred that the coating compositions manufactured using the functionalized silica particles according to the invention are curable coating compositions, in particular curable epoxy/amine coating compositions, Michael addition curing coating compositions, radical polymerization curing coating compositions, condensation curing coating compositions, and addition curing coating compositions.

The curable coating composition according to the present invention can be any coating composition capable of being cured, which refers to the toughening or hardening of a polymer material by a cross-linking of polymer chains by a chemical process. The curing process as mentioned before can be effected by heat, radiation, electron beams, or chemical additives, which also includes contact with moisture or oxygen from the ambient air, and characteristically entails an increase in viscosity or hardness. The term is also used in case monomers present in a composition bear more than one site for polymerization and polymerization and cross-linking of the monomers occur at the same time. This is for example the case in polyacrylate monomers, which comprise several acrylate moieties serving as sites for polymerization and cross-linking.

Further, the curable coating compositions according to the invention comprise diverse types of compositions, preferably curable epoxy coating compositions, Michael addition curing coating compositions, radical polymerization curing coating compositions, condensation curing coating compositions, and addition curing coating compositions, containing various organic polymers, mixtures of organic polymers and monomers, or monomers, for instance all kinds of polycarbonates, poly(meth)acrylates, polyolefins, polyurethanes, polyethers, polyesters, polyorganosiloxanes, various types of epoxy resins, such as glycidyl-based epoxy resins, novolac-based epoxy-resins or aliphatic epoxy resins, as well as various copolymers and mixtures of polymer compounds, and the corresponding monomers, i.e. mono(meth)acrylates, dimethyl carbonate and diols, in particular diphenylmethane derivatives, olefins, and polyisocyanates.

It is also preferred that the coating compositions according to the invention, in particular the curable coating compositions according to the invention optionally comprise further additives, such as further photoinitiators, light stabilizers, fillers, in particular carbon black, metal oxide particles and silica particles not according to the invention, functionalized silica compounds other than according to the invention, flame retardants, solvents, curing catalysts, reactive surface agents, colorants, stabilizers, preservatives, light stabilizers, surfactants, leveling agents, and other rheological agents.

In a preferred embodiment according to the invention, the coating composition comprising the silica particles according to the invention is a condensation curing coating composition comprising alkoxysilanes as curable component, a radical polymerization curing coating composition comprising poly(meth)acrylates as curable component, or a curable epoxy coating composition containing one or more epoxy compounds and one or more amine compounds as curable system.

In another preferred embodiment according to the invention, the coating composition comprising the silica particles according to the invention is a curable coating composition comprising acrylates, polyorganosiloxanes, alkoxysilanes, epoxides, amines, hydroxyacrylates, isocyanates or a combination of one or more of such curable monomers, oligomers or polymers as curable component.

Preferably, the coating composition comprising the silica particles according to the invention comprises an OH-terminated silicone oil, more preferably the coating composition comprising the silica particles according to the invention comprises an OH-terminated silicone oil and one or more silica particles according to the invention containing a polyether group in the moiety F, and most preferably the coating composition comprising the silica particles according to the invention comprises an OH-terminated silicone oil having an chain length (number of silicon atoms in the backbone) in the range of from 1 to about 400 and one or more silica particles according to the invention containing a polyether group in the moiety F.

Also preferably, the coating composition comprising the silica particles according to the invention comprises one or more acrylate or methacrylate resins, more preferably one or more acrylate or methacrylate resins and at least one functionalized silica particle according to the invention containing a polyether group or an amino group in the moiety F, most preferably the coating composition comprising the silica particles according to the invention comprises two or more acrylate or methacrylate resins and at least one functionalized silica particle according to the invention containing a polyether group or an amino group in the moiety F.

In still another embodiment according to the invention, the coating composition comprising the silica particles according to the invention comprises
one or more curable components selected from curable polymers, oligomers or monomers or binder
one or more types of functionalized silica particles according to the invention
optionally one or more light stabilizers
optionally one or more solvents
optionally one or more colorants
optionally one or more surfactants or other rheological additives
optionally one or more fillers
optionally one or more curing catalysts

Preferably, the one or more curable components and/or binders are selected from the group consisting of acrylates, methacrylates, hydroxyacrylates, esters, aromatics, phenols, epoxides, siloxanes or silanes and constitute about 20.0 to about 99.9 weight-%, preferably about 30.0 to about 99.5 weight-%, more preferably about 40.0 to about 99.0 weight-% of the total weight of the coating composition.

Preferably, the one or more types of functionalized silica particles according to the invention constitute up to about 90 weight-%, more preferably about 0.1 to about 80 weight-%, preferably about 0.5 to about 70 weight-%, more preferably about 1 to about 60 weight-% of the total weight of the coating composition.

Preferably, the light stabilizer is selected from the group consisting of hindered amine light stabilizers (HALS), benzophenone derivatives, benzotriazole derivatives, triazine derivatives, resorcinol derivatives, and triorganophosphite compounds and constitutes up to about 15 weight-% of the coating composition, more preferably about 0.2 to about 10 weight-%, even more preferably about 0.5 to about 8 weight-%, and most preferably about 1 to about 5 weight-% of the total weight of the coating composition.

Preferably, the solvent is selected from the group consisting of aliphatic hydrocarbons, cycloaliphatic hydrocarbons, aromatic hydrocarbons, diorganocarbonates, ethers, ketones, alcohols, esters and combinations thereof, and constitutes up to about 95 weight-% of the coating composition, more preferably 0 to about 90 weight-%, even more preferably 0 to about 80 weight-% of total weight of the coating composition.

Preferably, the colorant constitutes up to about 5 weight-% of the coating composition, more preferably about 0.01 to about 4.0 weight-%, even more preferably about 0.05 to about 2.0 weight-%, most preferably about 0.1 to about 1.5 weight-% of the total weight of the coating composition.

Preferably, the curing catalyst is selected from the group consisting of organotin, organozinc, organotitanium and organoboron compounds, primary amines, secondary amines, tertiary amines, ammonium, cyclic amines, aliphatic amines, metal oxides, metal hydroxides, metal carbonates, ammonia and combinations thereof and constitutes up to about 20 weight-% of the coating composition, more preferably about 0.1 to about 20.0 weight-%, even more preferably about 0.2 to about 5.0 weight-%, and most preferably about 1.0 to about 2.0 weight-% of the total weight of the coating composition.

Preferably, the filler is selected from the group selected from unmodified silica, modified silicas other than according to the invention, mica, talc, carbon black, titanium dioxide, calcium carbonate, barium sulfate, calcium carbonate and constitutes up to about 50 weight-% of the coating composition, more preferably about 0.5 to about 30.0 weight-%, even more preferably about 1.0 to about 20.0 weight-%, and most preferably about 2.0 to about 15.0 weight-% of total weight of the coating composition.

Preferably, the surfactants or other rheological additives constitutes about 0.01 to about 5.0 weight-% of the coating composition, more preferably about 0.05 to about 1.0 weight-%, even more preferably about 0.1 to about 0.5 weight-% of the total weight of the coating composition.

In a preferred embodiment according to the invention, the coating composition according to the invention comprises about 0.1 to about 80 weight-%, preferably about 0.5 to about 70 weight-%, more preferably about 1 to about 60 weight-%, still more preferably about 20 to about 55 weight-%, and most preferably about 25 to about 50 weight-% the silica particles according to the invention as defined in the above embodiments, based on the total weight of the coating compositions.

It is preferred that the coating composition according to the invention comprises more than about 1 weight-% of the silica particles, as the desired effect cannot be sufficiently achieved in many cases if a lower content of the silica particles is applied, and on the other hand, it is preferred that the coating composition comprises less than about 80 weight-% of the silica particles according to the invention, as a higher content of the silica may have negative effects on crack and fatigue resistance, such as described in the Handbook of Fillers (4th Edition)—8. The Effect of Fillers on the Mechanical Properties of Filled Materials, by ChemTec Publishing, which is incorporated by reference in its entirety herein. It is more preferred that the coating composition comprises 3 to 60 weight-% of the silica particles, and even more preferable the coating composition comprises 25 to 50 weight-% of the silica particles. It is noted that the optimum content of silica particles according to the invention in a coating composition also depends on the specific type of coating composition and the specific application of the coating.

### List of Preferred Embodiments According to the Invention

In the following, the preferred embodiments according to the invention are summarized:

1. Silica particles functionalized with one or more silanes of the formula:

HN[—SiR¹₂-A]₂ (1),

and/or

R¹ₓR²₃₋ₓSi-A (2)

wherein
R¹ is independently selected from non-hydrolyzable residues, preferably hydrocarbyl groups, more preferably alkyl groups, most preferably R¹ is methyl,
R² is independently selected from hydrolyzable residues, preferably selected from the group consisting of hydrogen, hydroxy, hydrocarbylcarbonyloxy groups, such as acyloxy groups, halogen groups, amino groups, hydrocarbyloxy groups, such as alkoxy or aryloxy groups, more preferably alkoxy groups,
x is 0, 1 or 2, and
A is a group of the formula

-M-F,

wherein
M is selected from L or a group of the formula:

-{L-[SiR¹₂O]ₚ—SiR¹₂}ₘ-L-, wherein

L is independently selected from the group consisting of divalent alkylene groups having at least two carbon atoms, which can be interrupted by one or more —O—, —NR³—C(O)—, and/or —NR³—, —OC(O)NR³—, —NR³—C(O)—NR³— moieties, and can be substituted by one or more OH groups, wherein R³ is hydrogen, Me₃Si— or C1-C8-alkyl, preferably L is a divalent C2-C12-alkylene group, more preferably a divalent C2-C4 alkylene group, most preferably L is —(CH₂)₂— and/or —(CH₂)₃—,
R¹ is as defined above,
p=1 to about 9, preferably p=1 or 4, more preferably p=4,
m=1 to about 20, preferably m=1,
and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups

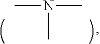

or quaternary ammonium groups

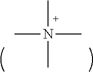

and may be substituted by OH groups, SH groups, halide groups, organosilyl groups or triorganosiloxy groups,
with the proviso that for the silanes of formula (2)
(i) A is a group of the formula
-{L-[SiR¹₂O]ₚ—SiR¹₂}ₘ-L-F, wherein L, R¹, p, m and F are as defined above,
   or
   (ii) A is a group of the formula
-L-F, wherein L contains at least one ether group (—O—), and optionally has at least one hydroxy substituent (—OH), and wherein F is as defined above with the proviso that it comprises at least one ester group (—O—C(═O)— or —C(═O)—O—).
   2. The silica particles according to embodiment 1, wherein in formula (1), when M is L, then the group F contains at least one heteroatom, such as N, O, P, S, Si, or a halogen atom, such as fluorine, chlorine, bromine or iodine.
   3. The silica particles according to embodiment 1 or 2, wherein in formula (1) the substituents of the hydrocarbyl radicals F are selected from the group consisting of hydroxyl, thiol, alkoxy, siloxy, perfluoroalkyl, carboxyl, ester, aminoalkyl, thioalkyl, or polyether groups, alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.
   4. The silica particles according to any of the previous embodiments, wherein F comprises, at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.
   5. The silica particles according to any of the previous embodiments, wherein F is selected from the group consisting of:
alkyl,
alkenyl,
alkylcarbonyloxy,
polyalkylene oxide groups, preferably of the general formula:

[—OC₂H₄]_{q}[—OC₃H₆]ᵣ[—OC₄H₈]ₛ—R⁴

wherein
[—OC₂H₄] represents an ethyleneoxy unit,
[—OC₃H₆] represents a propyleneoxy unit, and
[—OC₄H₆] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R⁴ is selected from the groups consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR¹₃, wherein R¹ is independently selected from the groups as defined above for formula (1) and (2), and siloxy groups such as —OSi(R¹)₃, wherein R¹ is independently selected from the groups as defined above for formula (1) and (2).
   6. The silica particles according to any of the previous embodiments, wherein the one or more silanes of the formula (1) and/or (2) are exclusively selected from hydrophobic silanes (i.e. from silanes wherein the log P value of the partition coefficient P_{oct/wat} of the compound H-L-F comprising the L-F-groups of the silane in a 50/50 mixture of water and octanol is equal or above 0.5).
   7. The silica particles according to any of the previous embodiments, wherein the one or more silanes of the formula (1) and/or (2) are exclusively selected from hydrophilic silanes (i.e. from silanes wherein the log P value of the partition coefficient of the compound H-L-F comprising the L-F-groups of the silane in a 50/50 mixture of water and octanol is below 0.5).
   8. The silica particles according to any of the previous embodiments, wherein the silica particles are functionalized with two or more different silanes of the formula (1) and/or (2).
   9. The silica particles according to embodiment 8, wherein each silica particle is functionalized by one or more hydrophobic silanes of the formula (1) and/or (2) and by one or more hydrophilic silanes of the formula (1) and/or (2).
   10. The silica particles according to embodiment 8, wherein in one or more of the silanes of the formula (1) and/or (2) the group F comprises one or more coating-matrix-reactive groups, and wherein the one or more further silanes of the formula (1) and/or (2) are either exclusively hydrophilic silanes or exclusively hydrophobic silanes.
   11. The silica particles according to embodiment 10, wherein the one or more further silanes of the formula (1) and/or (2) are exclusively hydrophilic silanes, and wherein the group F of the one or more hydrophilic silanes comprises one or more hydrophilic groups selected from the group consisting of polyhydroxylated alkyl groups, polyether groups, hydrocarbon groups comprising quaternary ammonium groups, hydrocarbon groups comprising carboxylate groups, and hydrocarbon groups comprising one or more amino groups.
   12. The silica particles according to embodiment 10, wherein the one or more further silanes of the formula (1) and/or (2) are exclusively hydrophobic silanes, and wherein the group F of the one or more hydrophobic silanes comprises one or more hydrophilic groups selected from the group consisting of linear or branched unsubstituted alkyl groups, alkyl groups comprising difluoromethylene and/or trifluoromethyl groups, in particular perfluorinated alkyl groups, alkyl groups bearing triorganosilyl groups, organosiloxy groups, alkenyl groups or aromatic groups without substituents containing heteroatoms, in particular alkaryl groups and aralkyl groups.
   13. The silica particles according to any of the previous embodiments, comprising at least two kinds of different silica particles functionalized with silanes of the formula (1) and/or (2).
   14. The silica particles according to any of the previous embodiments, comprising at least two kinds of silica particles functionalized with different silanes having a different polarity.
   15. The silica particles according to any of the previous embodiments, wherein the one or more silanes of the formula (1) and/or (2) are selected from the group consisting of:

R¹ₓR²₃₋ₓSi-L-[SiR¹₂O]ₚ—SiR¹₂-L-[—OC₂H₄]_{q}[—OC₃H₆]ᵣ[—OC₄H₈]ₛ—R⁴

R¹ₓR²₃₋ₓSi-L-[SiR¹₂O]ₚ—SiR¹₂-L-R⁵

HN{—SiR-L-[SiR¹₂O]ₚ—SiR¹₂-L-[—OC₂H₄]_{q}[—OC₃H₆]ᵣ[—OC₄H₈]ₛ—R⁴}₂

HN{—SiR¹₂-L-[SiR¹₂O]ₚ—SiR¹₂-L-R⁵}₂ and

R¹ₓR²₃₋ₓSi-L-[SiR¹₂O]ₚ—SiR¹₂-L-R⁵
wherein R¹, R², R⁴, L, p, q, r, s are each as defined in the previous embodiments, and R⁵ is selected from the group consisting of alkyl, alkylcarbonyloxy, glycidyl, glycidyloxy, organosilyl, such as —SiMe₂-O-SiMe₂-CHCH₂, —SiMe₃, —SiEt₃, —Si(iPr)₃, —SiPh₃, —Si(cyHex)₃, —SitBuMe₂, and —SitBuPh₂.
   16. The silica particles according to any of the previous embodiments, wherein R² is alkoxy.
   17. The silanes of the formula (1) as defined in embodiment 2.
   18. A process for the production of functionalized silica particles, comprising
contacting silica particles with one or more silanes of the formula (1) and/or (2):

HN[—SiR¹₂-A]₂ (1),

and/or

R¹ₓR²₃₋ₓSi-A (2)
as defined in embodiment 1.
   19. The process according to embodiment 18, wherein contacting the silica particles and the one or more silanes of the formula (1) and/or (2) is in the presence of a solvent.
   20. The process according to embodiment 18 or embodiment 19, wherein the silica particles and the one or more silanes of the formula (1) and/or (2) are contacted at a temperature above about 40° C., more preferably above about 50° C., most preferably at a temperature in the range of about 55° C. to about 120° C.
   21. The process according to any of embodiments 18 to 20, wherein the silica particles are selected from colloidal silica particles having an average particle size in the range from about 1 to about 300 nm, preferably about 1 to about 150 nm as determined by dynamic light scattering (DLS), or fumed silica having an average particle size in the range from about 1 to 5 about 600 μm, preferably about 20 to about 400 μm as determined by DLS or transmission electron microscopy (TEM).
   22. The process according to any of embodiments 18 to 21, wherein contacting the silica particles and the one or more silanes of the formula (1) and/or (2) is in the presence of a condensation catalyst selected from the group consisting of organotin, organozinc, organotitanium and organoboron compounds, primary amines, secondary amines, tertiary amines, ammonium compounds, cyclic amines, aliphatic amines, metal oxides, metal hydroxides, metal carbonates, ammonia and combinations thereof, preferably of organotin and organotitanium compounds.
   23. The process according to any of the embodiments 18-22, wherein in the silanes of the formula (1) the group M is L.
   24. The process according to any of the embodiments 18 to 23, wherein in the silanes of the formula (1) and/or (2) F is selected from the group consisting of:
alkyl,
alkenyl,
alkylcarbonyloxy, and
polyalkylene oxide groups, preferably of the general formula:

[—OC₂H₄]_{q}[—OC₃H₆]ᵣ[—OC₄H₈]ₛ—R⁴

wherein
[—OC₂H₄] represents an ethyleneoxy unit,
[—OC₃H₆] represents a propyleneoxy unit, and
[—OC₄H₈] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R⁴ is selected from the group consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR¹₃, wherein R¹ is independently selected from the groups as defined above for formula (1) and (2), and, siloxy groups such as —OSi(R¹)₃,
   wherein R¹ is independently selected from the groups as defined above for formula (1) and (2).
   25. The process according to any of the embodiments 18-24, wherein the group F of the one or more silanes of the formula (1) and/or (2) comprises at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.
   26. The process according to any of embodiments 18 to 25, wherein the one or more silanes of the formula (1) and/or (2) are exclusively selected from hydrophobic silanes, or wherein the one or more silanes of the formula (1) and/or (2) are exclusively selected from hydrophilic silanes.
   27. The process according to any of embodiments 18 to 26, wherein the silica particles are contacted with one or more silanes of the formula (2), wherein R² is an alkoxy group.
   28. The process according to any of the embodiments 18 to 27, wherein two or more silanes of the formula (1) and/or (2) as defined in in the previous embodiments are contacted with the silica particles in one step, or wherein two or more silanes of the formula (1) and/or (2) are contacted with silica particles in two or more steps.
   29. The process according to the previous embodiment 18 to 28, wherein the silica particles are contacted with one or more silanes of the formula (1) and/or (2) comprising one or more coating-matrix reactive moieties, and with one or more hydrophobic silanes of the formula (1) and/or (2) in the absence of hydrophilic silanes of the formula (1) and/or (2), or
   wherein the silica particles are contacted with one or more silanes of the formula (1) and/or (2) comprising one or more coating-matrix reactive moieties, and with one or more hydrophilic silanes of the formula (1) and/or (2) in the absence of hydrophobic silanes of the formula (1) or (2).
   30. The process according to any of the embodiments 18 to 28, wherein the silica particles are contacted with one or more silanes of the formula (1) in the presence of at least about 0.5 equivalents of water based on the molar amount of the silane or silanes of the formula (1), preferably in the presence of at least about 1.0 equivalent of water, most preferably in the presence of at least about 1.5 equivalents of water based on the molar amount of the silane or silanes of the formula (1).
   31. Functionalized silica particles comprising one or more monovalent groups A, wherein A is a group of the formula

-M-F,

wherein
M is selected from L or a group of the formula:

-{L-[SiR¹₂O]ₚ—SiR¹₂}ₘ-L-, wherein

L is independently selected from the group consisting of divalent alkylene groups having at least two carbon atoms, which can be interrupted by one or more —O—, —NR³—C(O)—, and/or —NR³—, —OC(O)NR³—, —NR³—C(O)—NR³— moieties, and can be substituted by one or more OH groups, wherein R³ is hydrogen, Me₃Si— or C1-C8-alkyl, preferably L is a divalent C2-C12-alkylene group, more preferably a divalent C2-C4 alkylene group, most preferably L is —(CH₂)₂— and/or —(CH₂)₃—,
R¹ is independently selected from non-hydrolyzable residues, preferably hydrocarbyl groups, more preferably alkyl groups, most preferably R¹ is methyl,
p=1 to about 9, preferably p=1 or 4, more preferably p=4,
m=1 to about 20, preferably m=1,
and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups

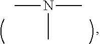

or quaternary ammonium groups

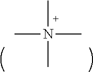

and may be substituted by OH groups, SH groups, halide groups, organosilyl groups or triorganosiloxy groups,
and the group A is bonded to the silica particle via a silicon atom which is linked to the silicon dioxide network of the silica particle via one or more oxygen atoms, wherein the valences of said silicon atom which are not occupied by the group -A or an oxygen atom are occupied by a substituent R¹ as defined above.
32. The functionalized silica particles according to embodiment 31, wherein M is L and the group F contains at least one heteroatom, such as N, O, P, S, Si, or a halogen atom, such as fluorine, chlorine, bromine or iodine.
33. The silica particles according to embodiment 31 or 32, wherein the substituents of the hydrocarbyl radicals F are selected from the group consisting of hydroxyl, thiol, alkoxy, siloxy, perfluoroalkyl, carboxyl, ester, aminoalkyl, thioalkyl, or polyether groups, alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.
34. The silica particles according to any of the embodiments 31 to 33, wherein F comprises at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino and isocyanate groups, ketones, diketones, 1,3-diketones, dicarboxy groups, 1,3-dicarboxy groups, diesters, 1,3-diesters, nitro (—NO₂), cyano (—CN), alkyl sulfonyl fluoride groups, as well as donor and acceptor groups in the Michael addition reaction.
35. The silica particles according to any of the embodiments 31 to 34, wherein F is selected from the group consisting of:
alkyl,
alkenyl,
alkylcarbonyloxy,
polyalkylene oxide groups, preferably of the general formula:

[—OC₂H₄]_{q}[—OC₃H₆]ᵣ[—OC₄H₈]ₛ—R⁴

wherein
[—OC₂H₄] represents an ethyleneoxy unit,
[—OC₃H₆] represents a propyleneoxy unit, and
[—OC₄H₈] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R⁴ is selected from the groups consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR¹₃, wherein R¹ is independently selected from the groups as defined above, and siloxy groups such as —OSi(R¹)₃, wherein R¹ is independently selected from the groups as defined above.
   36. The silica particles according to any of the embodiments 31 to 35, wherein the one or more groups A are exclusively selected from hydrophobic groups (i.e. from groups A wherein the log P value of the partition coefficient P_{oct/wat} of the compound H-L-F comprising the L-F-groups of the group A in a 50/50 mixture of water and octanol is equal or above 0.5).
   37. The silica particles according to any of the embodiments 31 to 36, wherein the one or more groups A of the formula (1) and/or (2) are exclusively selected from hydrophilic groups (i.e. from groups A wherein the log P value of the partition coefficient of the compound H-L-F comprising the L-F-groups of the group A in a 50/50 mixture of water and octanol is below 0.5).
   38. The silica particles according to any of the embodiments 31 to 37, wherein the silica particles are functionalized with two or more different groups A.
   39. The silica particles according to embodiment 38, wherein each silica particle is functionalized by one or more hydrophobic groups A and by one or more hydrophilic groups A.
   40. The silica particles according to embodiment 38, wherein in one or more of the groups A the group F comprises one or more coating-matrix-reactive groups, and wherein the one or more further groups A are either exclusively hydrophilic groups A or exclusively hydrophobic groups A.
   41. The silica particles according to embodiment 40, wherein the one or more further groups A are exclusively hydrophilic groups A, and wherein the group F of the one or more hydrophilic groups A comprises one or more hydrophilic groups selected from the group consisting of polyhydroxylated alkyl groups, polyether groups, hydrocarbon groups comprising quaternary ammonium groups, hydrocarbon groups comprising carboxylate groups, and hydrocarbon groups comprising one or more amino groups.
   42. The silica particles according to embodiment 40, wherein the one or more further groups A are exclusively hydrophobic silanes, and wherein the group F of the one or more hydrophobic groups A comprises one or more hydrophilic groups selected from the group consisting of linear or branched unsubstituted alkyl groups, alkyl groups comprising difluoromethylene and/or trifluoromethyl groups, in particular perfluorinated alkyl groups, alkyl groups bearing triorganosilyl groups, organosiloxy groups, alkenyl groups or aromatic groups without substituents containing heteroatoms, in particular alkaryl groups and aralkyl groups.
   43. The silica particles according to any of the embodiments 31 to 42, comprising at least two kinds of different silica particles functionalized with groups A.
   44. The silica particles according to any of the embodiments 31 to 43, comprising at least two kinds of silica particles functionalized with different groups A having a different polarity.
   45. The silica particles according to any of the embodiments 31 to 44, wherein the one or more silanes of the formula (1) and/or (2) are selected from the group consisting of:

-L-[SiR¹₂O]ₚ—SiR¹₂-L-[OC₂H₄]_{q}[—OC₃H₆]ᵣ[—OC₄H₈]ₛ—R⁴

-L-[SiR¹₂O]ₚ—SiR¹₂-L-R⁵

wherein R¹, R⁴, L, p, q, r, s are each as defined in the previous embodiments, and R⁵ is selected from the group consisting of alkyl, alkylcarbonyloxy, glycidyl, glycidyloxy, organosilyl, such as —SiMe₂-O—SiMe₂-CH═CH₂, —SiMe₃, —SiEt₃, —Si(iPr)₃, —SiPh₃, —Si(cyHex)₃, —SitBuMe₂, and —SitBuPh₂.
46. Use of the silica particles according to any of the embodiments 1 to 16, 31 to 45 or produced by the process according to any of the embodiments 18 to 30 for the manufacture of coating compositions.
47. Use of the silica particles according to any of the embodiments 1 to 16, 31 to 45 or produced by the process according to any of the embodiments 18 to 30 as marine anti-fouling additives, general anti-fouling additives, anti-ice additives, anti-dirt additives, anti-fog additives, self-cleaning additives, anti-adhesion anti-dust, anti-fingerprint, and anti-graffiti additives, in particular as general anti-fouling additives or anti-fog additives in coating compositions.
48. Coating compositions comprising the silica particles according to any of the embodiments 1 to 16, 31 to 45 or produced by the process according to any of the embodiments 18 to 30.
49. Coating compositions according to the previous embodiment 48 comprising from about 0.1 to about 80 weight-%, preferably from about 0.5 to about 70 weight-%, more preferably from about 1 to about 60 weight-%, still more preferably from about 20 to about 55 weight-%, and most preferably from about 25 to about 50 weight-% of the silica particles, based on the total weight of the coating compositions.

### EXAMPLES

The following abbreviations and trade names are used in the examples section:

Me=methyl (—CH₃)
Aerosil 300 (BET 270-330 m²/g; SiO₂ content >99.8%; particle size: 5-50 nm primary particles size, 100 μm average agglomerate size); Breox AA E 450H (BASF), Lamoreaux catalyst (abcr) VeoVa9 (vinyl ester of Versatic™ acid 9, a synthetic saturated monocarboxylic acid of highly branched structure containing ten carbon atoms, Hexion); Levasil EXP 310 from AkzoNobel (dispersion of silica in water; silica content: 30 weight-%; particle size: 10 nm; BET of silica: 200 m²g⁻¹); Epikote 828 EL (epoxy resin prepared from bisphenol A and epichlorohydrin, Hexion); Silopren E0.5 (di-hydroxy-terminated linear polysiloxane base polymer with a viscosity of 0.5 Pa·s at 20° C.; Momentive Performance Materials); Silopren E2 (di-hydroxy-terminated linear polysiloxane base polymer with a viscosity of 2 Pa·s at 20° C.; Momentive Performance Materials).

### Example 1 (Starting Material)

Preparation of NH(SiMe₂-(CH₂)₂—SiMe₂(OSiMe₂)₃—O—SiMe₂-(CH₂)₃Me)₂

150.5 g n-butyl hydrogenopentasiloxane (HSiMe₂(OSiMe₂)₃—SiMe₂-(CH₂)₃Me), and 58.5 g dimethylvinylchlorosilane were reacted under N₂ for 3 hours at 100° C. upon the addition of 0.06 g Lamoreaux catalyst (3 weight % Pt solution).

The reaction mixture was further heated to 80° C. and the reaction flask was degassed. To the reaction, a stream of NH₃ was slowly added until a pressure increase by using a digital pressure sensor indicated the completion of the reaction by liberation of HCl. The reaction mixture was further stirred at 50° C. and 100 mbar NH₃ elevated pressure for 1.5 hours. Thereafter, the reaction flask was degassed (to <30 mbar) for 1 hour at 50° C. The product was filtrated using a Seitz® K Series grade EK filter pad from PALL (1400 mass/unit area g/2, thickness 3.8 mm).

### Example 2 (Starting Material)

Preparation of NH(SiMe₂-(CH₂)₃—(O—CH₂CH₂)_{7.5}—OMe)₂

900 g of allyl methyl capped polyether (CH₂═CH—CH₂—(O—CH₂CH₂)_{7.5}—OCH₃) were dissolved in 270 mL of xylene and heated to 80°. Ca. 0.5 g of a platinum catalyst (Lamoreaux) was added (in total 10 ppm Pt) and a mixture of 261 g dimethylchlorosilane in 450 mL xylene was added dropwise. The reaction mixture was stirred at 100° C. for 12 hours before the remaining dimethylchlorosilane was removed under vacuum at 40° C.

170 g of the obtained hydrosilylation product were dissolved in 100 mL of xylene. The reaction flask was degassed and a stream of NH₃ was slowly added until the pressure increase indicated the completion of the substitution reaction replacing the chloro atoms by an amino group. The reaction mixture was further stirred at 50° C. and 100 mbar NH₃ elevated pressure for 1.5 hours. Thereafter, the reaction flask was degassed (to <30 mbar) for 1 hour at 50° C. The product was filtrated using a Seitz® K Series grade EK filter pad from PALL (1400 mass/unit area g/m², thickness 3.8 mm).

### Example 3 (Starting Material)

Preparation of NH(SiMe₂-(CH₂)₃—(OCH₂CH₂)₁₀—OSiMe₃)₂

200 g of allyl polyether Breox AA E 450H (CH₂═CH—CH₂—(O—CH₂CH₂)₁₀—OH) were dissolved in 400 mL of xylene. A mixture of 14.3 g trimethylchlorosilane and 21.3 g hexamethylene disilazane (both used as OH capping agents of the allyl polyether) was added dropwise at room temperature. The reaction mixture was then stirred for 3 hours at room temperature. Precipitated NH₄Cl was removed via filtration. The solvent was removed under vacuum at 60° C. 58 g of the obtained product were heated to 80° C. and ca. 64 mg of a platinum catalyst was added (Lamoreaux, 10 ppm Pt in total). 11.4 g of dimethylchlorosilane (HSi(Me₂)Cl) were added dropwise. Then the reaction mixture was heated to 120° C. and stirred for 4 hours.

220 g of thus obtained product were dissolved in 100 mL of xylene. The reaction flask was degassed and a stream of NH₃ was slowly added until the pressure increase indicated the completion of the reaction. The reaction mixture was further stirred at 50° C. and 100 mbar NH₃ elevated pressure for 1.5 hours. Thereafter, the reaction flask was degassed (to <30 mbar) for 1 hour at 50° C. The product was filtrated using a Seitz® K Series grade EK filter pad from PALL (1400 mass/unit area g/m², thickness 3.8 mm).

### Example 4

Functionalization of Silica Using NH(SiMe₂-(CH₂)₂—SiMe₂(OSiMe₂)₃—O—SiMe₂-(CH₂)₃Me)₂ (Example 1)

20 g Aerosil® 300 were dispersed in 200 ml dioxane followed by the addition of 4.31 g deionized water and 36.9 g NH(SiMe₂-(CH₂)₂—SiMe₂(OSiMe₂)₃—O—SiMe₂-(CH₂)₃Me)₂ (example 1). The mixture was heated to 100° C. under argon atmosphere. Over the reaction time of 1 hour, the reaction slurry became less viscous and less turbid, indicating that the surface functionalization reaction of SiOH surface groups with SiMe₂-(CH₂)₂—SiMe₂(OSiMe₂)₃—O—SiMe₂-(CH₂)₃Me occurred. The dispersion was used without further purification and contained ca. 8 weight-% of silica.

### Example 5

### Preparation of Polyether Pentasiloxane Functionalized Silica

The monodispersed polyether pentasiloxane (MeO)₃Si—(CH₂)₂—SiMe₂(OSiMe₂)₃—SiMe₂-(CH₂)₃—(OCH₂CH₂)₁₀—OH) was prepared according to example 6 of WO 2017/012714 A1. 10 g Aerosil® 300 were dispersed in 250 g toluene followed by the addition of 0.12 g diisopropoxy-bis(ethylacetoacetato)titanate. The mixture was heated to 80° C. and 2.0 g (MeO)₃Si—(CH₂)₂—SiMe₂(OSiMe₂)₃—SiMe₂-(CH₂)₃—(OCH₂CH₂)₁₀—OH) were added slowly. Thereafter, the slurry was heated under reflux for 6 hours. The solvent was removed in vacuo (50° C./<1 mbar) to yield a pale yellow powder (˜12 g).

### Example 6

### Preparation of Polyether Functionalized Silica

20 g Aerosil® 300 were dispersed in 200 ml dioxane followed by the addition of 4.31 g deionized water and 36.9 g of NH(SiMe₂-(CH₂)₃—(O—CH₂CH₂)_{7.5}—OMe)₂ (example 2). The mixture was heated to 100° C. under argon atmosphere. Over the reaction time of 1 hour, the reaction slurry became less viscous and less turbid, indicating the surface functionalization reaction. The dispersion was used without further purification and contained ca. 8 weight-% percent of silica.

### Example 7

### Preparation of VeoVa9 Pentasiloxane Functionalized Silica

This example relates to the functionalization of Aerosil® 300 with the monodispersed (MeO)₃Si—(CH₂)₂—SiMe₂(OSiMe₂)₃—O—SiMe₂(CH₂)₂—OC(O)—C(Me)R^{a}R^{b}, with R^{a}, R^{b} are each alkyl with in total 6 C-Atoms.

The monodispersed VeoVa9 pentasiloxane (MeO)₃Si—(CH₂)₂—SiMe₂(OSiMe₂)₃—SiMe₂-(CH₂)₂—OC(O)—C(CH₃)R^{a}R^{b}, with R^{a} and R^{b}=alkyl, with Rₐ and R_{b} having in total 6 C-Atoms was prepared according to example 7 of WO 2017/012714 A1 by reacting VeoVa 9 [from Hexion] with M^{H}-D₃-M^{H}, and subsequently with vinyltrimethoxysilane.
10 g Aerosil® 300 were dispersed in 250 g toluene followed by the addition of 0.12 g diisopropoxy-bis(ethylacetoacetato)titanate. The mixture was heated to 80° C. and 2.0 g of the monodispersed (MeO)₃Si—(CH₂)₂—SiMe₂(OSiMe₂)₃—SiMe₂-(CH₂)₂—OC(O)—C(CH₃)R^{a}R^{b} (with R^{a}+R^{b}=alkyl with in total 6 C-Atoms) were slowly added. Thereafter, the slurry was heated under reflux for 6 hours. The solvent was removed in vacuo (50° C./<1 mbar) to yield into pale yellow powder (10.5 g).

### Example 8

Colloidal Silica Nanoparticles Dispersed in 1-methoxy-2-propanol

To 100 g of a dispersion of silica nanoparticles in water (Levasil EXP 310 from AkzoNobel, 30 weight-% silica), 44 g of 1-methoxy-2-propanol (Dowanol PM) were added. A rotary evaporator was used to remove ca. 20-25 weight-% of the solvent mixture. The procedure was repeated twice, yielding dispersed silica nanoparticles in 1-methoxy-2 propanol. The mixture contains still 10-15 weight-% water as measured by Karl Fischer method.

### Example 9

NH(SiMe₂-(CH₂)₃—(O—CH₂CH₂)_{7.5}—OMe)₂-Functionalized Colloidal Silica Nanoparticles

60 g of a dispersion of silica nanoparticles in 1-methoxy-2-propanol (example 8) were mixed with ca. 517 g of 1-methoxy-2-propanol (Dowanol PM) (final SiO₂-content: 3 weight-%) and heated to 80° C. under reflux and N₂ inert atmosphere. A solution of 15 g NH(SiMe₂-(CH₂)₃—(O—CH₂CH₂)_{7.5}—OMe)₂ (example 2) in 15 mL 1-methoxy-2-propanol was then added dropwise through a funnel. The mixture was stirred for 8 hours under reflux. Then a part of the solvent was removed under vacuum to yield a liquid product with a silica content of 40 weight-%.

### Example 10

NH(SiMe₂-(CH₂)₃—(OCH₂CH₂)₁₀—OSiMe₃)₂ Functionalized Colloidal Silica Nanoparticles

60 g of a dispersion of silica nanoparticles in 1-methoxy-2-propanol (example 8) were mixed with ca. 517 g of 1-methoxy-2-propanol (final SiO₂ content: 3 weight-%) and heated to 80° C. A solution of 15 g NH(SiMe₂-(CH₂)₃—(OCH₂CH₂)₁₀—OSiMe₃)₂ (example 3) in 15 mL 1-methoxy-2-propanol was then added dropwise. The mixture was stirred for 8 hours under reflux. Then a part of the solvent was removed under vacuum to yield a liquid product with a silica content of 15 weight-%.

### APPLICATION EXAMPLES

### Preparation of an Anti-Fouling Coating Formulation

In order to test the activity of the functionalized silica particles, coating formulations were prepared and coated test panels were immersed into the sea (The Northern Sea, Harbour of Norderney). A representative example for the prepared coating formulations was made as follows:

### Application Example 1 (Anti-Fouling Tests)

Using the functionalized Aerosil 300® particles according to the invention example 4, 5, 6 and 7, the following coating composition was prepared.

An adduct was prepared from the reaction of Epikote 828 EL (epoxy resin prepared from bisphenol A and epichlorohydrin from Hexion), and a silane A-1100 at a weight ratio of 34/47 and described as follows:
34.0 g of Epikote 828 EL and 47.0 g of silane A-1100 were dissolved in 70 g of xylene and heated to 80° C. for 6 h.
Silane A-1100 is gamma-aminotriethoxysilane:

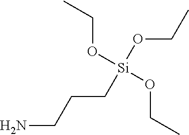

*SiPEG was prepared as described in WO 2014/126599 A1 and is represented by the following formula:

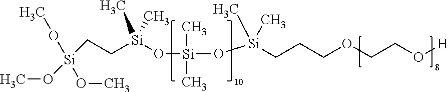

### Composition 990-G

TABLE 1

| | | |
|---|---|---|
| SiPEG* | 72.6 | g |
| Adduct Epikote 828 EL + A-1100 (application | 47.6 | g |
| example 1) | | |
| Tetrapropylorthosilicate | 7.3 | g |
| Momentive Silopren E 0.5 | 246.0 | g |
| Momentive Silopren E2 | 288.8 | g |
| Dibutyltin Dilaurate (DBTL) | 5.4 | g |
| Polyether pentasiloxane functionalized silica | 290.1 | g |
| particles (example 5) | | |

### Composition 993-G

TABLE 2

| | | |
|---|---|---|
| SiPEG* | 72.7 | g |
| Adduct Epikote 828 EL + A-1100 (application | 47.7 | g |
| example 1) | | |
| Tetrapropylorthosilicate | 7.3 | g |
| Momentive Silopren E2 | 535.4 | g |
| Dibutyltin Dilaurate (DBTL) | 5.4 | g |
| VeoVa9 pentasiloxane functionalized silica | 290.4 | g |
| particles (example 7) | | |

### Composition 994-G

TABLE 3

| | |
|---|---|
| Momentive Silopren E 0.5 | 257.4 g |
| Momentive Silopren E2 | 302.1 g |
| VeoVa9 pentasiloxane functionalized silica | 220.4 g |
| particles (example 7) | |
| Polyether pentasiloxane functionalized silica | 220.4 g |
| particles (example 5) | |

### Composition 1101-G

TABLE 4

| | | |
|---|---|---|
| SiPEG* | 60.0 | g |
| Adduct Epikote 828 EL + A-1100 (application | 39.3 | g |
| example 1) | | |
| Tetrapropylorthosilicate | 7.3 | g |
| Momentive Silopren E 0.5 | 203.3 | g |
| Momentive Silopren E2 | 238.7 | g |
| Dibutyltin dilaurate (DBTL) | 4.5 | g |
| Polyether functionalized silica | 239.7 | g |
| particles (example 6) | | |

### Composition 1103-G

TABLE 5

| | | |
|---|---|---|
| SiPEG* | 63.2 | g |
| Adduct Epikote 828 EL + A-1100 (application | 41.4 | g |
| example 11) | | |
| Tetrapropylorthosilicate | 6.3 | g |
| Momentive Silopren E 0.5 | 214.2 | g |
| Momentive Silopren E2 | 251.4 | g |
| Dibutyltin Dilaurate (DBTL) | 4.7 | g |
| Butyl pentasiloxane functionalized silica | 252.5 | g |
| particles (example 4) | | |

The primed (50 μm coating thickness) PVC test (Simona) panels were prepared using the below primer composition
component A: mixture of Epikure 3292-FX-60 (aliphatic amine curing agent for epoxy coatings), xylene, SF1706 (a silicone fluid is a curable polymer that contains amine functional and dimethylpolysiloxane units) in a weight ratio of 60:19:0.95.
component B: Epon Resin 828 (a difunctional bisphenol A/epichlorohydrin derived liquid epoxy resin)
   wherein component A and component B are mixed in a 10:7.2 weight ratio.
   The primed panels were cured for 24 hours at room temperature.
   The coating formulations 990-G to 1103-G indicated above were then applied with a coating knife (300 μm coating thickness) on the above primed PVC test panels (purchased from Simona AG). The coating was cured at room temperature for one day and subsequently immersed into the sea The Northern Sea, Harbour of Norderney (by Dr. Brill+Partner GmbH). The fouling release evaluation was conducted according to the international ASTM standard ASTM D6990-05 (2011) (Standard test method for the evaluation of marine biofouling on coated test panels).

The following results were observed (Fouling rating 100=free of fouling, 0=surface covered with fouling):

### Marine Anti-Fouling Assessment on the Test Panels:

TABLE 6

Days

| sample no. | example no. | 0 | 22 | 48 | 708 |
|---|---|---|---|---|---|
| 990-G | 5 | 100 | 99 | 99 | not |
| | | | | | measured |
| 993-G | 7 | 100 | 99 | 98 | not |
| | | | | | measured |
| 994-G | Mixture of ex | 100 | 99 | 99 | 85 |
| | 5 and ex 7 | | | | |
| | (50/50 | | | | |
| | weight-%) | | | | |
| 1101-G | 6 | 100 | 99 | 96 | not |
| | | | | | measured |
| 1103-G | 4 | 100 | 99 | 97 | not |
| | | | | | measured |
| PVC-4 | none | 100 | 73 | 72 | 0 |

PVC-4 was used as a reference (PVC without surface treatment).

The results show in comparison to the reference PVC panel that an anti-fouling/fouling release effect can be observed for examples 4, 5, 6 and 7, which is long lasting, even for almost 2 years in the case of the mixture of Ex. 5 and Ex. 7 (50/50 weight).

### Application Example 2 (Anti-Fog Tests)

### Preparation of an Anti-Fog Formulation

In order to test the anti-fog performance of the functionalized particles, the particles have been added to a UV cure coating formulation. Contact angles as well as the anti-fog performances have been measured and evaluated.

### Description of the Coating Composition

The coating formulation consists of (i) a (meth)acrylate resin based on 30 parts by mass of 2-acetoacetoxyethyl methacrylate (AAEM), 50 parts by mass of dimethylacrylamide (DMAA), 10 parts by mass of methyl methacrylate (MMA), 10 parts by mass of butyl methacrylate (BMA) with a total molecular weight of Mw 30.000; (ii) an acrylate oligomer dipentaerythritol penta/hexa-acrylate (DPHA); (iii) 1,8-diazabicyclo[5.4.0]undec-7-ene (DBU) as catalyst; and (iv) a polyether-siloxane copolymer as leveling agent. Methoxypropanol is used as solvent.

The coating formulation was prepared by mixing all components at room temperature and flow coated onto polycarbonate test plates yielding in a coating thickness of 2-8 μm. After a flash-off period of approx. 5 min at room temperature, the coated panels were put in an oven at 120° C. for approx. 20 in.

TABLE 7

| | Component | Formulation 1 | | Formulation 2 | | Formulation 3 | |
|---|---|---|---|---|---|---|---|
| (meth)acrylate resin | | 53 | g | 53 | g | 53 | g |
| functionalized colloidal | ex. 9 | 5.1 | g | | | | |
| silica nanoparticles | ex. 10 | | | 13.5 | g | | |
| acrylate monomer | DPHA | 2.2 | g | 2.2 | g | 2.2 | g |
| DBU | catalyst | 0.09 | g | 0.09 | g | 0.09 | g |
| 1-methoxy-2-propanol | solvent | 47.5 | g | 49.6 | g | 40.9 | g |
| butanol | solvent | 2.7 | g | 2.7 | g | 2.7 | g |
| polyether-siloxane | flow additive | 0.015 | g | 0.15 | g | 0.015 | g |
| copolymer | | | | | | | |

| | | | |
|---|---|---|---|
| Anti-fog Test* | pass | pass | fail |

*Anti-fog Test acc. GMW 16508; 3.3.6 (This specification covers the qualification requirements for a clear anti-condensation coating to be used on the inside surface of the outer lens of an exterior lamp assembly).

The formulation 1 (containing the functionalized silica particles of example 9 according to the invention) and the formulation 2 (containing the functionalized silica particles of example 10 according to the invention) showed an improvement in the anti-fog properties compared to the reference without surface treated silica particles.

### Anti-Fog Performance Evaluation

### Contact Angle Measurement

The water contact angle measurements were performed with a drop shape analyzer Krüss DAS100 using the sessile drop method. Deionized and filtered (0.2 μm filter) water was used.

The analyzed droplet volume was 3.5 μL.
The results of the water contact angle measurements after 60 seconds for the formulations 1, 2 and 3 are given in the following table.

TABLE 8

| Formulation | 1 | 2 | 3 |
|---|---|---|---|
| Contact Angle (°) | 12 | 20 | 35 |
| after 60 sec. | | | |

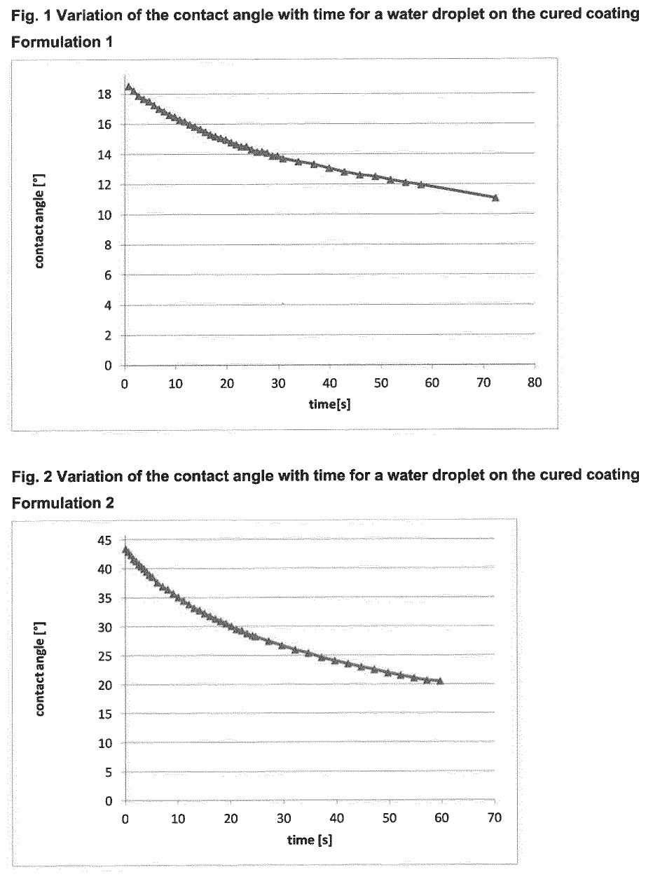

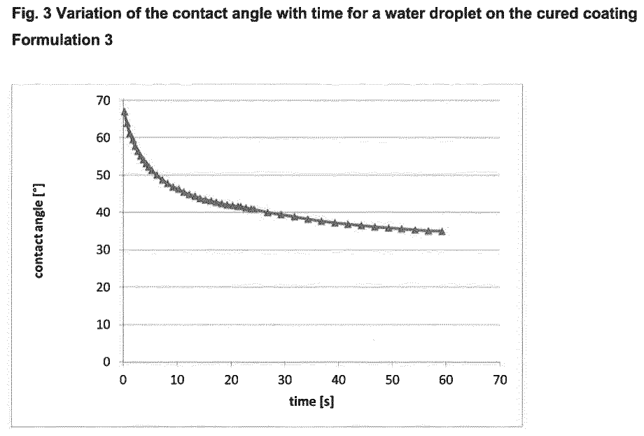

In the FIGS. 1 to 3 the results of contact angle measurements with formulations 1 to 3 are shown. The lower contact angles, especially the one of formulation 1, indicates an increase of the hydrophilicity of the surface which is corroborated by the enhanced antifog performance.

### Anti-Fog Test

The test plate was placed in a distance of 15 cm over a water bath heated to 60° C. and the anti-fog performance was evaluated over a period of 90 seconds following the GMW16508 specification, section 3.3.6.

### Results Anti-Fog Test

TABLE 9

| Sample | Observation |
|---|---|
| Formulation 1 | No fogging for at least 90 seconds |
| Formulation 2 | Fogging occurs after 38 seconds |
| Formulation 3 | Fogging occurs after 3 seconds. |

1. Silica particles functionalized with one or more silanes of the formula:
HN[—SiR12-A]2 (1),
and/or
R1xR23-xSi-A (2)
wherein
R1 is independently selected from non-hydrolyzable residues, preferably hydrocarbyl groups, more preferably alkyl groups, most preferably R1 is methyl,
R2 is independently selected from hydrolyzable residues, preferably selected from the group consisting of hydrogen, hydroxy, hydrocarbylcarbonyloxy groups, such as acyloxy groups, halogen groups, amino groups, hydrocarbyloxy groups, such as alkoxy or aryloxy groups, more preferably alkoxy groups,
x is 0, 1 or 2, and
A is a group of the formula
-M-F,
wherein
M is selected from L or a group of the formula:
-{L-[SiR12O]p—SiR12}m-L-, wherein
L is independently selected from the group consisting of divalent alkylene groups having at least two carbon atoms, which can be interrupted by one or more —O—, —NR3-C(O)—, and/or —NR3-, —OC(O)NR3-, —NR3-C(O)—NR3-moieties, and can be substituted by one or more OH groups, wherein R³ is hydrogen, Me3Si— or C1-C8-alkyl, preferably L is a divalent C2-C12-alkylene group, more preferably a divalent C2-C4 alkylene group, most preferably L is —(CH2)2- and/or —(CH2)3-,
R1 is as defined above,
p=1 to about 9, preferably p=1 or 4, more preferably p=4,
m=1 to about 20, preferably m=1,
and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups 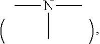
or quaternary ammonium groups 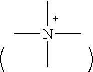
and may be substituted by OH groups, SH groups, halide groups, organosilyl groups or triorganosiloxy groups,
with the proviso that for the silanes of formula (2)
(i) A is a group of the formula
-{L-[SiR12O]p—SiR12}m-L-F, wherein L, R1, p, m and F are as defined above,
or
(ii) A is a group of the formula
-L-F, wherein L contains at least one ether group (—O—), and optionally has at least one hydroxy substituent (—OH), and wherein F is as defined above with the proviso that it comprises at least one ester group (—O—C(═O)— or —C(═O)—O—).

2. The silica particles according to claim 1, wherein in formula (1), when M is L, then the group F contains at least one heteroatom, such as N, O, P, S, Si, or a halogen atom, such as fluorine, chlorine, bromine or iodine.

3. The silica particles according to claim 1, wherein F comprises at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino and isocyanate groups, ketones, diketones, 1,3-diketones, dicarboxy groups, 1,3-dicarboxy groups, diesters, 1,3-diesters, nitro (—NO2), cyano (—CN), alkyl sulfonyl fluoride groups, as well as donor and acceptor groups in the Michael addition reaction,
or wherein F is selected from the group consisting of:
alkyl,
alkenyl,
alkylcarbonyloxy,
polyalkylene oxide groups, preferably of the general formula:
[—OC2H4]q[—OC3H6]r[—OC4H8]s-R4
wherein
[—OC2H4] represents an ethyleneoxy unit,
[—OC3H6] represents a propyleneoxy unit, and
[—OC4H8] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R4 is selected from the groups consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR13, wherein R1 is independently selected from the groups as defined above for formula (1) and (2), and siloxy groups such as —OSi(R1)3, wherein R1 is independently selected from the groups as defined above for formula (1) and (2).

4. The silica particles according to claim 1, wherein the one or more silanes of the formula (1) and/or (2) are exclusively selected from hydrophobic silanes (i.e. from silanes wherein the log P value of the partition coefficient Poct/wat of the compound H-L-F comprising the L-F-groups of the silane in a 50/50 mixture of water and octanol is equal or above 0.5).

5. The silica particles according to claim 1, wherein the one or more silanes of the formula (1) and/or (2) are exclusively selected from hydrophilic silanes (i.e. from silanes wherein the log P value of the partition coefficient of the compound H-L-F comprising the L-F-groups of the silane in a 50/50 mixture of water and octanol is below 0.5).

6. The silica particles according to claim 1, wherein the silica particles are functionalized with two or more different silanes of the formula (1) and/or (2).

7. The silica particles according to claim 6, wherein each silica particle is functionalized by one or more hydrophobic silanes of the formula (1) and/or (2) and by one or more hydrophilic silanes of the formula (1) and/or (2).

8. The silica particles according to claim 6, wherein in one or more of the silanes of the formula (1) and/or (2) the group F comprises one or more coating-matrix-reactive groups, and wherein the one or more further silanes of the formula (1) and/or (2) are either exclusively hydrophilic silanes or exclusively hydrophobic silanes, wherein preferably the group F of the one or more hydrophilic silanes comprises one or more hydrophilic groups selected from the group consisting of polyhydroxylated alkyl groups, polyether groups, hydrocarbon groups comprising quaternary ammonium groups, hydrocarbon groups comprising carboxylate groups, and hydrocarbon groups comprising one or more amino groups, or wherein preferably the group F of the one or more hydrophobic silanes comprises one or more hydrophilic groups selected from the group consisting of linear or branched unsubstituted alkyl groups, alkyl groups comprising difluoromethylene and/or trifluoromethyl groups, in particular perfluorinated alkyl groups, alkyl groups bearing triorganosilyl groups, organosiloxy groups, alkenyl groups or aromatic groups without substituents containing heteroatoms, in particular alkaryl groups and aralkyl groups.

9. The silanes of the formula (1) as defined in claim 2.

10. A process for the production of functionalized silica particles, comprising
contacting silica particles with one or more silanes of the formula (1) and/or (2):
HN[—SiR12-A]2 (1),
and/or
R1xR23-xSi-A (2)
as defined in claim 1,
wherein preferably the silica particles are contacted with one or more silanes of the formula (2) wherein R2 is an alkoxy group, and
wherein optionally contacting the silica particles and the one or more silanes of the formula (1) and/or (2) is in the presence of a solvent, and
optionally the silica particles and the one or more silanes of the formula (1) and/or (2) are contacted at a temperature above about 40° C., more preferably above about 50° C., most preferably at a temperature in the range of about 55° C. to about 120° C.,
further optionally contacting the silica particles and the one or more silanes of the formula (1) and/or (2) is in the presence of a condensation catalyst selected from the group consisting of organotin, organozinc, organotitanium and organoboron compounds, primary amines, secondary amines, tertiary amines, ammonium compounds, cyclic amines, aliphatic amines, metal oxides, metal hydroxides, metal carbonates, ammonia and combinations thereof, preferably of organotin and organotitanium compounds, and further optionally the silica particles are contacted with one or more silanes of the formula (1) in the presence of at least about 0.5 equivalent of water based on the molar amount of the silane or silanes of the formula (1), preferably in the presence of at least about 1.0 equivalent of water, most preferably in the presence of at least about 1.5 equivalents of water based on the molar amount of the silane or silanes of the formula (1).

11. The process according to claim 10, wherein in the silanes of the formula (1) and/or (2) F is selected from the group consisting of:
alkyl,
alkenyl,
alkylcarbonyloxy, and
polyalkylene oxide groups, preferably of the general formula:
[—OC2H4]q[—OC3H6]r[—OC4H8]s-R4
wherein
[—OC2H4] represents an ethyleneoxy unit,
[—OC3H6] represents a propyleneoxy unit, and
[—OC4H8] represents a butyleneoxy unit,
q=0 to about 40, preferably 0 to about 20, more preferably 1 to about 15,
r=0 to about 30, preferably 0 to about 20, more preferably 0 to about 10,
s=0 to about 20, preferably 0 to about 15, more preferably 0 to about 10,
with q+r+s>2,
R4 is selected from the group consisting of hydroxyl, alkoxy, alkylcarbonyloxy, hydroxyalkyl, siloxy groups, such as triorganosiloxy groups, organosilyl, glycidyl and glycidyloxy groups,
glycidyl and glycidyloxy groups,
organosilyl groups, such as —SiR13, wherein R1 is independently selected from the groups as defined above for formula (1) and (2), and, siloxy groups such as —OSi(R1)3, wherein R1 is independently selected from the groups as defined above for formula (1) and (2),
or wherein the group F of the one or more silanes of the formula (1) and/or (2) comprises at least one moiety selected from the group consisting of polyether moieties, ester moieties and coating-matrix-reactive moieties, such as alkenyl, epoxy, acrylate, methacrylate, thiol, hydroxyl, alkoxy, carboxy (—COOH), amino, alkoxysilyl and isocyanate groups, ketones, diketones, 1,3-diketones, dicarboxy groups, 1,3-dicarboxy groups, diesters, 1,3-diesters, nitro (—NO2), cyano (—CN), alkyl sulfonyl fluoride groups, as well as donor and acceptor groups in the Michael addition reaction.

12. The process according to claim 10, wherein two or more silanes of the formula (1) and/or (2) are contacted with the silica particles in one step, or wherein two or more silanes of the formula (1) and/or (2) are contacted with silica particles in two or more steps, and wherein preferably the silica particles are contacted with one or more silanes of the formula (1) and/or (2) comprising one or more coating-matrix reactive moieties, and with one or more hydrophobic silanes of the formula (1) and/or (2) in the absence of hydrophilic silanes of the formula (1) and/or (2), or
wherein preferably the silica particles are contacted with one or more silanes of the formula (1) and/or (2) comprising one or more coating-matrix reactive moieties, and with one or more hydrophilic silanes of the formula (1) and/or (2) in the absence of hydrophobic silanes of the formula (1) or (2).

13. Functionalized silica particles comprising one or more monovalent groups A,
wherein A is a group of the formula
-M-F,
wherein
M is selected from L or a group of the formula:
-{L-[SiR12O]p—SiR12}m-L-, wherein
L is independently selected from the group consisting of divalent alkylene groups having at least two carbon atoms, which can be interrupted by one or more —O—, —NR3-C(O)—, and/or —NR3-, —OC(O)NR3-, —NR3-C(O)—NR3-moieties, and can be substituted by one or more OH groups, wherein R3 is hydrogen, Me3Si— or C1-C8-alkyl, preferably L is a divalent C2-C12-alkylene group, more preferably a divalent C2-C4 alkylene group, most preferably L is —(CH2)2- and/or —(CH2)3-,
R1 is independently selected from non-hydrolyzable residues, preferably hydrocarbyl groups, more preferably alkyl groups, most preferably R1 is methyl,
p=1 to about 9, preferably p=1 or 4, more preferably p=4,
m=1 to about 20, preferably m=1,
and
F is selected from the group consisting of optionally substituted, straight-chain, cyclic or branched, saturated, unsaturated or aromatic hydrocarbyl groups which have up to about 100 carbon atoms, and which optionally contain one or more groups selected from —O—, —S—, —NH—, —C(O)—, —C(S)—, tertiary amino groups 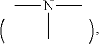
or quaternary ammonium groups 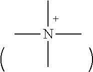
and may be substituted by OH groups, SH groups, halide groups, organosilyl groups or triorganosiloxy groups,
and the group A is bonded to the silica particle via a silicon atom which is linked to the silicon dioxide network of the silica particle via one or more oxygen atoms, wherein the valences of said silicon atom which are not occupied by the group -A or an oxygen atom are occupied by a substituent R1 as defined above.

14. The process according to claim 10, comprising using the silica particles for the manufacture of coating compositions, preferably as marine anti-fouling additives, general anti-fouling additives, anti-ice additives, anti-dirt additives, anti-fog additives, self-cleaning additives, anti-adhesion anti-dust, anti-fog, anti-fingerprint, and anti-graffiti additives, in particular as general anti-fouling additives or anti-fog additives in coating compositions.

15. Coating compositions comprising the silica particles according to claim 1, preferably comprising from about 0.1 to about 80 weight-%, more preferably from about 0.5 to about 70 weight-%, even more preferably from about 1 to about 60 weight-%, still more preferably from about 20 to about 55 weight-%, and most preferably from about 25 to about 50 weight-% of the silica particles, based on the total weight of the coating compositions.
